(19) United States
(12) Patent Application Publication
(10) Pub. No.: US 2019/0204959 A1
(43) Pub. Date: Jul. 4, 2019

(54) TOUCH INPUT DEVICE

(71) Applicant: HiDeep Inc., Seongnam-si, Gyeonggi-do (KR)

(72) Inventors: Beom Kyu Ko, Seongnam-si, Gyeonggi-do (KR); Bon Kee Kim, Seongnam-si, Gyeonggi-do (KR)

(73) Assignee: HiDeep, Inc., Seongnam-si, Gyeonggi-do (KR)

(21) Appl. No.: 16/331,709

(22) PCT Filed: Aug. 9, 2017
(86) PCT No.: PCT/KR2017/008622

§ 371 Date: Mar. 8, 2019

(30) Foreign Application Priority Data
Sep. 8, 2016 (KR) 10-2016-0115369

(51) Int. Cl. G06F 3/044; G06F 3/041; G02F 1/1333

(52) U.S. Cl. CPC G06F 3/044; G06F 2203/04105; G02F 1/13338; G06F 3/0416

(57) ABSTRACT

A touch input device capable of detecting pressure of a touch on a touch surface may be provided. The touch input device includes: a display module including a display panel; a substrate which is disposed below the display module and is a reference potential layer; and one or more pressure electrodes which are formed on the display panel. The display panel includes electrodes used to drive the display panel. A drive signal Tx which is applied to the pressure electrode is simultaneously applied to one or more of the electrodes used to drive the display panel. A capacitance which is detected at the pressure electrode is changed by a distance change between the pressure electrode and the substrate due to the pressure applied to the touch surface. A magnitude of the pressure applied to the touch surface is calculated based on the detected capacitance calculated from the capacitance which is detected at the pressure electrode.

### CROSS-REFERENCE TO RELATED PATENT APPLICATIONS

The present application is a U.S. National Stage Application under 35 U.S.C. § 371 of PCT Application No. PCT/KR2017/008622, filed Aug. 9, 2017, which claims priority to Korean Patent Application No. 10-2016-0115369, filed Sep. 8, 2016. The disclosures of the aforementioned priority applications are incorporated herein by reference in their entireties.

### TECHNICAL FIELD

The present disclosure relates to a touch input device and more particularly to a touch input device capable of improving a signal-to-noise ratio (SNR) by significantly reducing or removing a parasitic capacitance formed between a pressure electrode for pressure detection and a display panel or a substrate on which the pressure electrode is formed.

### BACKGROUND ART

Various kinds of input devices are being used to operate a computing system. For example, the input device includes a button, key, joystick and touch screen. Since the touch screen is easy and simple to operate, the touch screen is increasingly being used to operate the computing system.

The touch screen may constitute a touch surface of a touch input device including a touch sensor panel which may be a transparent panel including a touch-sensitive surface. The touch sensor panel is attached to the front side of a display screen, and then the touch-sensitive surface may cover the visible side of the display screen. The touch screen allows a user to operate the computing system by simply touching the touch screen by a finger, etc. Generally, the computing system recognizes the touch and a position of the touch on the touch screen and analyzes the touch, and thus, performs operations in accordance with the analysis.

Here, there is a demand for a touch input device capable of detecting not only the touch position of the touch on the touch screen but an exact pressure magnitude of the touch.

### DISCLOSURE

### Technical Problem

The purpose of the present invention is to provide a touch input device in which a parasitic capacitance formed between a pressure electrode and a display panel or a substrate on which the pressure electrode is formed can be significantly reduced or removed in a change amount of a capacitance detected at the pressure electrode.

### Technical Solution

One embodiment is a touch input device capable of detecting pressure of a touch on a touch surface. The touch input device includes: a display module including a display panel; a substrate which is disposed below the display module and is a reference potential layer; and one or more pressure electrodes which are formed on the display panel. The display panel includes electrodes used to drive the display panel. A drive signal Tx which is applied to the pressure electrode is simultaneously applied to one or more of the electrodes used to drive the display panel. A capacitance which is detected at the pressure electrode is changed by a distance change between the pressure electrode and the substrate due to the pressure applied to the touch surface. A magnitude of the pressure applied to the touch surface is calculated based on the detected capacitance calculated from the capacitance which is detected at the pressure electrode.

The pressure electrode may be disposed apart from the electrodes used to drive the display panel.

The pressure electrode may be formed directly on the display panel.

The display panel may include a first substrate layer and a second substrate layer which is disposed under the first substrate layer. The pressure electrode may be formed directly on a bottom surface of the second substrate layer.

The touch input device may further include a pressure sensor including the pressure electrode. The pressure sensor further may include a first insulation layer and a second insulation layer. The pressure electrode may be disposed between the first insulation layer and the second insulation layer. One of the first insulation layer and the second insulation layer may be attached to the display panel.

Another embodiment is a touch input device capable of detecting pressure of a touch on a touch surface. The touch input device includes: a display module which includes a display panel and has a reference potential layer; a substrate which is disposed below the display module; and one or more pressure electrodes which are formed on the substrate. A drive signal Tx which is applied to the pressure electrode is simultaneously applied to the substrate. A capacitance which is detected at the pressure electrode is changed by a distance change between the pressure electrode and the reference potential layer due to the pressure applied to the touch surface. A magnitude of the pressure applied to the touch surface is calculated based on the detected capacitance calculated from the capacitance which is detected at the pressure electrode.

The pressure electrode may be formed directly on the substrate.

The touch input device may further include a pressure sensor including the pressure electrode. The pressure sensor may further include a first insulation layer and a second insulation layer. The pressure electrode may be disposed between the first insulation layer and the second insulation layer. One of the first insulation layer and the second insulation layer may be attached to the substrate.

Further another embodiment is a touch input device capable of detecting pressure of a touch on a touch surface. The touch input device includes: a display module which includes a display panel; a substrate disposed below the display module; a first pressure electrode formed on the display panel; and a second pressure electrode formed on the substrate. The display panel includes electrodes used to drive the display panel. A drive signal Tx which is applied to one of the first pressure electrode and the second pressure electrode is simultaneously applied to at least one of the substrate and at least one of the electrodes used to drive the display panel. A capacitance detected at the other electrode to which no drive signal is applied among the first pressure electrode and the second pressure electrode is changed by a distance change between the first pressure electrode and the second pressure electrode due to the pressure applied to the touch surface. A magnitude of the pressure applied to the touch surface is calculated based on the detected capacitance calculated from the capacitance which is detected at the other pressure electrode.

The first pressure electrode may be disposed apart from the electrodes used to drive the display panel.

The one of the first pressure electrode and the second pressure electrode may be the first pressure electrode, and the other electrode may be the second pressure electrode.

The first pressure electrode may be formed directly on the display panel.

The touch input device may further include a pressure sensor including the second pressure electrode. The pressure sensor may further include a first insulation layer and a second insulation layer. The second pressure electrode may be disposed between the first insulation layer and the second insulation layer. One of the first insulation layer and the second insulation layer may be attached to the substrate.

The display panel may be bent by the pressure applied to the touch surface.

### Advantageous Effects

According to the embodiment of the present invention, it is possible to provide a touch input device capable of significantly reducing or removing a parasitic capacitance which is formed between a pressure electrode and a display panel or substrate on which the pressure electrode is formed, in a change amount of a capacitance detected at the pressure electrode.

### DESCRIPTION OF DRAWINGS

FIGS. 1a and 1b are schematic views of a capacitance type touch sensor panel and the configuration for the operation of the touch sensor panel;

FIGS. 2a and 2b are conceptual views showing the configuration of a display module in a touch input device;

FIG. 3a is a cross sectional view of an exemplary electrode sheet type pressure sensor including a pressure electrode according to an embodiment of the present invention;

FIG. 3b is a cross sectional view of the touch input device according to a first example, which is for describing a method for significantly reducing or removing a parasitic capacitance formed between the display module 200 and the pressure electrodes 450 and 460 in a change amount of a capacitance detected from the pressure electrodes 450 and 460;

FIG. 3c is a cross sectional view of the touch input device according to a second example, which is for describing a method for significantly reducing or removing a parasitic capacitance formed between the display module 200 and the pressure electrodes 450 and 460 in the change amount of the capacitance detected from the pressure electrodes 450 and 460;

FIG. 3d is a cross sectional view of the touch input device according to a third example, which is for describing a method for significantly reducing or removing a parasitic capacitance formed between a substrate 300 and the pressure electrodes 450 and 460 in the change amount of the capacitance detected from the pressure electrodes 450 and 460;

FIG. 3e is a cross sectional view of the touch input device according to a fourth example, which is for describing a method for significantly reducing or removing a parasitic capacitance formed between the substrate 300 and the pressure electrodes 450 and 460 in the change amount of the capacitance detected from the pressure electrodes 450 and 460;

FIG. 3f is a cross sectional view of the touch input device according to a fifth example, which is for describing a method for significantly reducing or removing a parasitic capacitance formed between the display module 200 and the pressure electrodes 450 and 460 in the change amount of the capacitance detected from the pressure electrodes 450 and 460;

FIGS. 4a to 4f show the first embodiment in which the electrode sheet according to the embodiment of the present invention is applied to the touch input device;

FIGS. 5a to 5i show the second example in which the electrode sheet according to the embodiment of the present invention is applied to the touch input device;

FIGS. 6a to 6h show the third example in which the electrode sheet according to the embodiment of the present invention is applied to the touch input device;

FIGS. 7a to 7e show a pressure electrode pattern included in the electrode sheet for pressure detection according to the embodiment of the present invention;

FIGS. 8a and 8b show a relationship between the magnitude of touch pressure and a saturated area in the touch input device to which the electrode sheet according to the embodiment of the present invention is applied;

FIGS. 9a to 9d show a cross section of the electrode sheet according to the embodiment of the present invention;

FIGS. 10a and 10b show the fourth example in which the electrode sheet according to the embodiment of the present invention is applied to the touch input device;

FIGS. 11a and 11b show a method for attaching the electrode sheet according to the embodiment of the present invention;

FIGS. 12a to 12c show a method for connecting the electrode sheet according to the embodiment of the present invention to a touch sensing circuit;

FIGS. 13a to 13d show a configuration in which the electrode sheet according to the embodiment of the present invention includes a plurality of channels;

FIGS. 14a to 14c show an example in which a pressure sensor according to the embodiment of the present invention is directly formed in the touch input device; and

FIGS. 15a to 15c show forms of a first electrode and a second electrode which are included in the electrode sheet according to the embodiment of the present invention.

### MODE FOR INVENTION

The following detailed description of the present invention shows a specified embodiment of the present invention and will be provided with reference to the accompanying drawings. The embodiment will be described in enough detail that those skilled in the art are able to embody the present invention. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. It should be understood that various embodiments of the present invention are different from each other and need not be mutually exclusive. Similar reference numerals in the drawings designate the same or similar functions in many aspects.

Hereinafter, a pressure sensor for pressure detection according to an embodiment of the present invention and a touch input device will be described with reference to the accompanying drawings. While a capacitance type touch sensor 10 is described below, a technique of detecting a touch position in another way according to the embodiment can be applied.

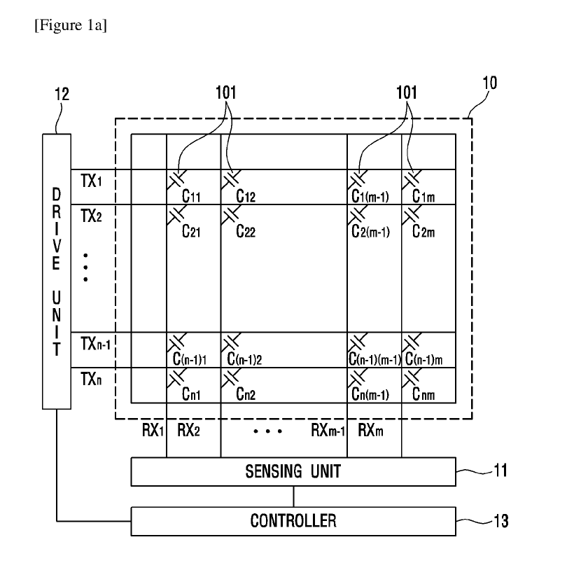

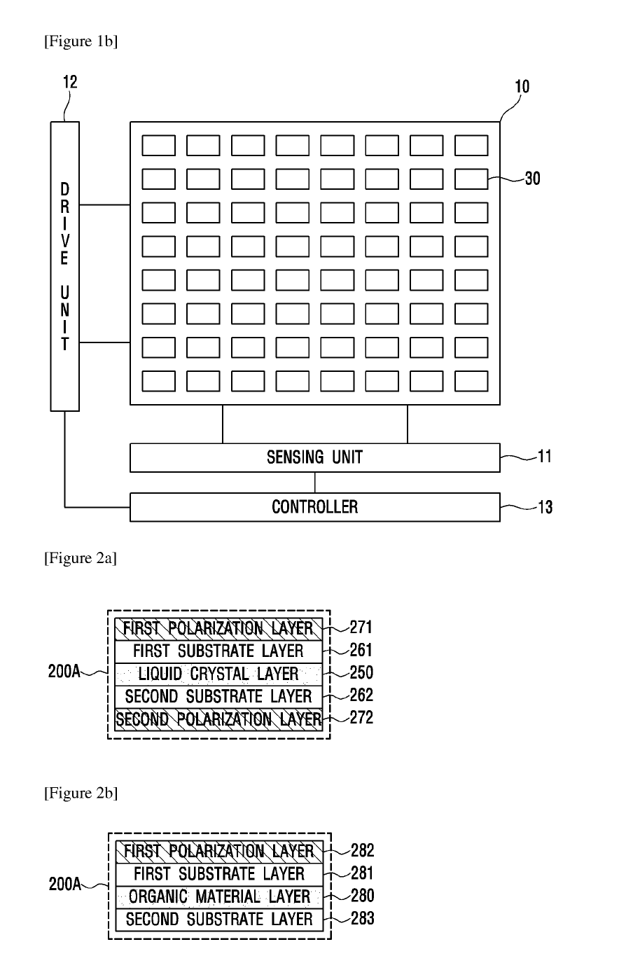

FIG. 1 is a schematic view of a capacitance type touch sensor 10 included in the touch input device according to the embodiment of the present invention and the configuration for the operation thereof. Referring to FIG. 1a, the touch sensor 10 may include a plurality of drive electrodes TX1 to TXn and a plurality of receiving electrodes RX1 to RXm, and may include a drive unit 12 which applies a drive signal to the plurality of the drive electrodes TX1 to TXn for the purpose of the operation of the touch sensor 10, and a sensing unit 11 which detects the touch and the touch position by receiving a sensing signal including information on a capacitance change amount changing according to the touch on a touch surface of the touch sensor 10.

As shown in FIG. 1a, the touch sensor 10 may include the plurality of drive electrodes TX1 to TXn and the plurality of receiving electrodes RX1 to RXm. While FIG. 1a shows that the plurality of drive electrodes TX1 to TXn and the plurality of receiving electrodes RX1 to RXm of the touch sensor 10 form an orthogonal array, the present invention is not limited to this. The plurality of drive electrodes TX1 to TXn and the plurality of receiving electrodes RX1 to RXm has an array of arbitrary dimension, for example, a diagonal array, a concentric array, a 3-dimensional random array, etc., and an array obtained by the application of them. Here, “n” and “m” are positive integers and may be the same as each other or may have different values. The magnitude of the value may be changed depending on the embodiment.

As shown in FIG. 1a, the plurality of drive electrodes TX1 to TXn and the plurality of receiving electrodes RX1 to RXm may be arranged to cross each other. The drive electrode TX may include the plurality of drive electrodes TX1 to TXn extending in a first axial direction. The receiving electrode RX may include the plurality of receiving electrodes RX1 to RXm extending in a second axial direction crossing the first axial direction.

In the touch sensor 10 according to the embodiment of the present invention, the plurality of drive electrodes TX1 to TXn and the plurality of receiving electrodes RX1 to RXm may be formed in the same layer. For example, the plurality of drive electrodes TX1 to TXn and the plurality of receiving electrodes RX1 to RXm may be formed on the same side of an insulation layer (not shown). Also, the plurality of drive electrodes TX1 to TXn and the plurality of receiving electrodes RX1 to RXm may be formed in the different layers. For example, the plurality of drive electrodes TX1 to TXn and the plurality of receiving electrodes RX1 to RXm may be formed on both sides of one insulation layer (not shown) respectively, or the plurality of drive electrodes TX1 to TXn may be formed on a side of a first insulation layer (not shown) and the plurality of receiving electrodes RX1 to RXm may be formed on a side of a second insulation layer (not shown) different from the first insulation layer.

The plurality of drive electrodes TX1 to TXn and the plurality of receiving electrodes RX1 to RXm may be made of a transparent conductive material (for example, indium tin oxide (ITO) or antimony tin oxide (ATO) which is made of tin oxide (SnO₂), and indium oxide (In₂O₃), etc.), or the like. However, this is only an example. The drive electrode TX and the receiving electrode RX may be also made of another transparent conductive material or an opaque conductive material. For instance, the drive electrode TX and the receiving electrode RX may be formed to include at least any one of silver ink, copper, nano silver, or carbon nanotube (CNT). Also, the drive electrode TX and the receiving electrode RX may be made of metal mesh.

The drive unit 12 according to the embodiment of the present invention may apply a drive signal to the drive electrodes TX1 to TXn. In the embodiment of the present invention, one drive signal may be sequentially applied at a time to the first drive electrode TX1 to the n-th drive electrode TXn. The drive signal may be applied again repeatedly. This is only an example. The drive signal may be applied to the plurality of drive electrodes at the same time in accordance with the embodiment.

Through the receiving electrodes RX1 to RXm, the sensing unit 110 receives the sensing signal including information on a capacitance (Cm) 101 generated between the receiving electrodes RX1 to RXm and the drive electrodes TX1 to TXn to which the drive signal has been applied, thereby detecting whether or not the touch has occurred and where the touch has occurred. For example, the sensing signal may be a signal coupled by the capacitance (Cm) 101 generated between the receiving electrode RX and the drive electrode TX to which the drive signal has been applied. As such, the process of sensing the drive signal applied from the first drive electrode TX1 to the n-th drive electrode TXn through the receiving electrodes RX1 to RXm can be referred to as a process of scanning the touch sensor 10.

For example, the sensing unit 11 may include a receiver (not shown) which is connected to each of the receiving electrodes RX1 to RXm through a switch. The switch becomes the on-state in a time interval in which the signal of the corresponding receiving electrode RX is detected, thereby allowing the receiver to detect the sensing signal from the receiving electrode RX. The receiver may include an amplifier (not shown) and a feedback capacitor coupled between the negative (−) input terminal of the amplifier and the output terminal of the amplifier, i.e., coupled to a feedback path. Here, the positive (+) input terminal of the amplifier may be connected to the ground or a reference voltage. Also, the receiver may further include a reset switch which is connected in parallel with the feedback capacitor. The reset switch may reset the conversion from current to voltage that is performed by the receiver. The negative input terminal of the amplifier is connected to the corresponding receiving electrode RX and receives and integrates a current signal including information on the capacitance (Cm) 101, and then converts the integrated current signal into voltage. The sensing unit 11 may further include an analog to digital converter (ADC) (not shown) which converts the integrated data by the receiver into digital data. Later, the digital data may be input to a processor (not shown) and processed to obtain information on the touch on the touch sensor 10. The sensing unit 11 may include the ADC and processor as well as the receiver.

A controller 13 may perform a function of controlling the operations of the drive unit 12 and the sensing unit 11. For example, the controller 13 generates and transmits a drive control signal to the drive unit 12, so that the drive signal can be applied to a predetermined drive electrode TX1 for a predetermined time period. Also, the controller 13 generates and transmits a sensing control signal to the sensing unit 11, so that the sensing unit 11 may receive the sensing signal from the predetermined receiving electrode RX for a predetermined time period and perform a predetermined function.

As described above, a capacitance (C) with a predetermined value is formed at each crossing of the drive electrode TX and the receiving electrode RX. When an object such as a finger approaches close to the touch sensor 10, the value of the capacitance may be changed. In FIG. 1a, the capacitance may represent a mutual capacitance (Cm). The sensing unit 11 detects such electrical characteristics, thereby detecting whether the touch has occurred on the touch sensor 10 or not and where the touch has occurred. For example, the sensing unit 11 is able to detect whether the touch has occurred on the surface of the touch sensor panel 100 comprised of a two-dimensional plane consisting of a first axis and a second axis.

More specifically, when the touch occurs on the touch sensor 10, the drive electrode TX to which the drive signal has been applied is detected, so that the position of the second axial direction of the touch can be detected. Likewise, when the touch occurs on the touch sensor 10, the capacitance change is detected from the reception signal received through the receiving electrode RX, so that the position of the first axial direction of the touch can be detected.

The foregoing has described in detail the mutual capacitance type touch sensor 10 as the touch sensor 10. However, in the touch input device 1000 according to the embodiment of the present invention, the touch sensor 10 for detecting whether or not the touch has occurred and the touch position may be implemented by using not only the above-described method but also any touch sensing method such as a self-capacitance type method, a surface capacitance type method, a projected capacitance type method, a resistance film method, a surface acoustic wave (SAW) method, an infrared method, an optical imaging method, a dispersive signal technology, and an acoustic pulse recognition method, etc.

Hereinafter, a component corresponding to the drive electrode TX and the receiving electrode RX for detecting whether or not the touch has occurred and/or the touch position can be referred to as a touch sensor.

In FIG. 1a, the drive unit 12 and the sensing unit 11 may constitute a touch sensor controller capable of detecting whether the touch has occurred on the touch sensor 10 according to the embodiment of the present invention or not and/or where the touch has occurred. The touch sensor controller according to the embodiment of the present invention may further include the controller 13. The touch sensor controller according to the embodiment of the present invention may be integrated and implemented on a touch sensing integrated circuit (IC, not shown) in the touch input device 1000 including the touch sensor 10. The drive electrode TX and the receiving electrode RX included in the touch sensor 10 may be connected to the drive unit 12 and the sensing unit 11 included in the touch sensing IC through, for example, a conductive trace and/or a conductive pattern printed on a circuit board, or the like. The touch sensing IC may be located on a circuit board on which the conductive pattern has been printed. According to the embodiment, the touch sensing IC may be mounted on a main board for operation of the touch input device 1000.

Up to now, although the operation mode of the touch sensor 10 sensing the touch position has been described on the basis of the mutual capacitance change amount between the drive electrode TX and the receiving electrode RX, the embodiment of the present invention is not limited to this. That is, as shown in FIG. 1b, it is also possible to detect the touch position on the basis of the change amount of a self-capacitance.

FIG. 1b is schematic views of a configuration of another capacitance type touch sensor 10 included in a touch input device according to another embodiment of the present invention and the operation of the capacitance type touch sensor. A plurality of single electrodes 30 are provided on the touch sensor 10 shown in FIG. 1b. Although the plurality of single electrodes 30 may be, as shown in FIG. 1b, disposed at a regular interval in the form of a grid, the present invention is not limited to this.

The drive control signal generated by the controller 13 is transmitted to the drive unit 12. On the basis of the drive control signal, the drive unit 12 applies the drive signal to the predetermined touch electrode 30 for a predetermined time period. Also, the sensing control signal generated by the controller 13 is transmitted to the sensing unit 11. On the basis of the sensing control signal, the sensing unit 11 receives the sensing signal from the predetermined single electrode 30 for a predetermined time period. Here, the sensing signal may be a signal for the change amount of the self-capacitance formed on the single electrode 30.

Here, whether the touch has occurred on the touch sensor 10 or not and/or the touch position are detected by the sensing signal detected by the sensing unit 11. For example, since the coordinate of the single electrode 30 has been known in advance, whether the touch of the object on the surface of the touch sensor 10 has occurred or not and/or the touch position can be detected.

In the foregoing, for convenience of description, it has been described that the drive unit 12 and the sensing unit 11 operate individually as a separate block. However, the operation to apply the drive signal to the single electrode 30 and to receive the sensing signal from the single electrode 30 can be also performed by one drive and sensing unit.

Hereinafter, a display module 200 included in the touch input device 1000 will be described.

In the touch input device to which the pressure sensor according to the embodiment of the present invention is applicable, the touch sensor 10 for detecting the touch position may be positioned outside or inside the display module 200.

The display module of the touch input device 1000 to which the pressure sensor according to the embodiment of the present invention is applicable may be a display panel included in a liquid crystal display (LCD), a plasma display panel (PDP), an organic light emitting diode (OLED), etc. Accordingly, a user may perform the input operation by touching the touch surface while visually identifying an image displayed on the display panel. Here, the display module 200 may include a control circuit which receives an input from an application processor (AP) or a central processing unit (CPU) on a main board for the operation of the touch input device 1000 and displays the contents that the user wants on the display panel. The control circuit may be mounted on a second printed circuit board (hereafter, referred to as a second PCB) (210) in FIGS. 11a to 13d. Here, the control circuit for the operation of the display module 200 may include a display panel control IC, a graphic controller IC, and a circuit required to operate other display panels 200.

FIGS. 2a and 2b are conceptual views showing the configuration of the display module in the touch input device to which the pressure sensor according to the embodiment of the present invention is applicable. While FIGS. 2a and 2b show an LCD panel or an OLED panel as a display panel 200A included within the display module 200, this is just an example. Any display panel may be applied to the touch input device 1000.

First, the configuration of the display panel 200A using the LCD panel will be described with reference to FIG. 2a.

In the present specification, the reference numeral 200A may refer to the display panel included in the display module 200. As shown in FIG. 2a, the LCD panel 200A may include a liquid crystal layer 250 including a liquid crystal cell, a first substrate layer 261 and a second substrate layer 262 which are disposed on both sides of the liquid crystal layer 250 and include electrodes, a first polarization layer 271 formed on a side of the first substrate layer 261 in a direction facing the liquid crystal layer 250, and a second polarization layer 272 formed on a side of the second substrate layer 262 in the direction facing the liquid crystal layer 250. Here, the first substrate layer 261 may be made of color filter glass, and the second substrate layer 262 may be made of TFT glass. Also, according to the embodiment, at least one of the first substrate layer 261 and the second substrate layer 262 may be made of a bendable material such as plastic. In FIG. 2a, the second substrate layer 262 may be comprised of various layers including a data line, a gate line, TFT, a common electrode Vcom, and a pixel electrode, etc. These electrical components may operate in such a manner as to generate a controlled electric field and orient liquid crystals located in the liquid crystal layer 250.

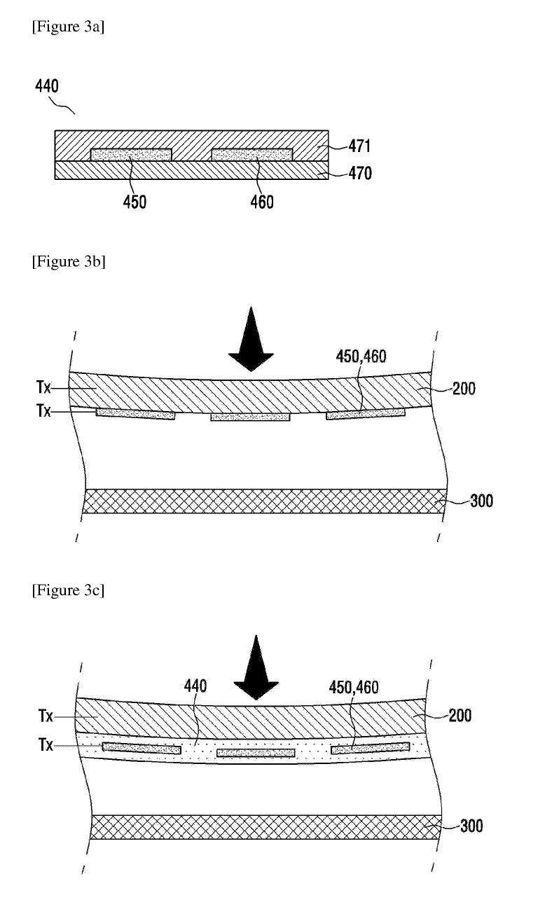

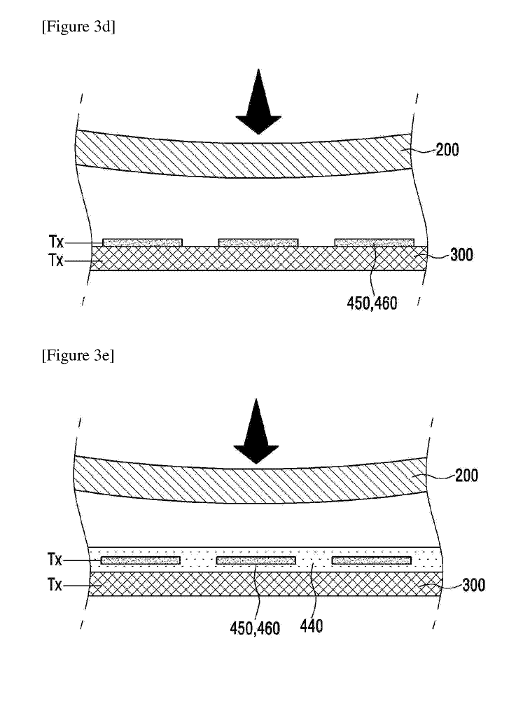

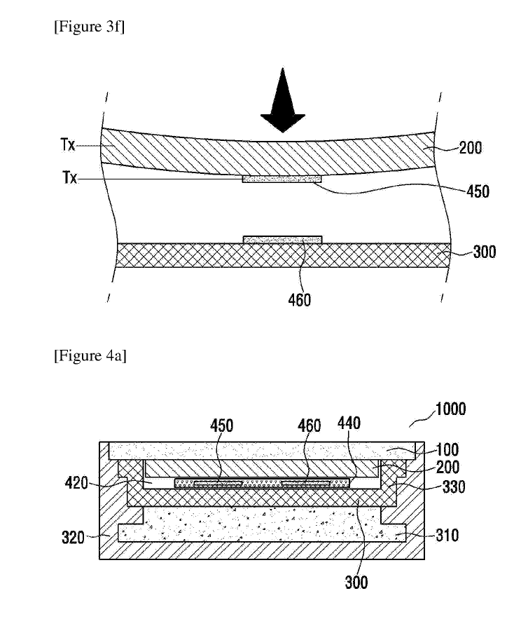

Next, the configuration of the display panel 200A using the OLED panel will be described with reference to FIGS. 3d to 3f.

As shown in FIGS. 3d to 3f, the OLED panel may include an organic material layer 280 including an organic light-emitting diode (OLED), a first substrate layer 281 and a second substrate layer 283 which are disposed on both sides of the organic material layer 280 and include electrodes, and a first polarization layer 282 formed on a side of the first substrate layer 281 in a direction facing the liquid crystal layer 250. Here, the first substrate layer 281 may be made of encapsulation glass, and the second substrate layer 283 may be made of TFT glass. Also, according to the embodiment, at least one of the first substrate layer 281 and the second substrate layer 283 may be made of a bendable material such as plastic. The OLED panel shown in FIGS. 3d to 3f may include an electrode used to drive the display panel 200A, such as a gate line, a data line, a first power line (ELVDD), a second power line (ELVSS), etc. The organic light-emitting diode (OLED) panel is a self-light emitting display panel which uses a principle where, when current flows through a fluorescent or phosphorescent organic thin film and then electrons and electron holes are combined in the organic material layer, so that light is generated. The organic material constituting the light emitting layer determines the color of the light.

Specifically, the OLED uses a principle in which when electricity flows and an organic matter is applied on glass or plastic, the organic matter emits light. That is, the principle is that electron holes and electrons are injected into the anode and cathode of the organic matter respectively and are recombined in the light emitting layer, so that a high energy exciton is generated and the exciton releases the energy while falling down to a low energy state and then light with a particular wavelength is generated. Here, the color of the light is changed according to the organic matter of the light emitting layer.

The OLED includes a line-driven passive-matrix organic light-emitting diode (PM-OLED) and an individual driven active-matrix organic light-emitting diode (AM-OLED) in accordance with the operating characteristics of a pixel constituting a pixel matrix. None of them require a backlight. Therefore, the OLED enables a very thin display module to be implemented, has a constant contrast ratio according to an angle and obtains good color reproductivity depending on a temperature. Also, it is very economical in that non-driven pixel does not consume power.

In terms of operation, the PM-OLED emits light only during a scanning time at a high current, and the AM-OLED maintains a light emitting state only during a frame time at a low current. Therefore, the AM-OLED has a resolution higher than that of the PM-OLED and is advantageous for driving a large area display panel and consumes low power. Also, a thin film transistor (TFT) is embedded in the AM-OLED, and thus, each component can be individually controlled, so that it is easy to implement a delicate screen.

It will be apparent to a skilled person in the art that the LCD panel or the OLED panel may further include other structures so as to perform the display function and may be deformed.

Here, the touch surface of the touch input device 1000 is the outer surface of the display module 200 and may be the top surface or the bottom surface of FIGS. 2a and 2b. In FIGS. 2a and 2b, the top surface of the display module 200, which can be the touch surface, may be covered with a cover layer (not shown) like glass.

The foregoing has described the display module 200 included in the touch input device 1000. Hereinafter, described in detail is an example of a case of detecting touch pressure by applying the pressure sensor according to the embodiment of the present invention to the touch input device 1000.

The pressure sensor according to the embodiment of the present invention may be formed in the form of an electrode sheet and may be attached to the touch input device 1000 including the display module 200 and a substrate 300. The display module 200 of the touch input device 1000 according to the embodiment of the present invention may include the display panel 200A and a display drive electrode for driving the display panel 200A. Specifically, when the display panel 200A other than the display drive electrode is an LCD panel, the display module 200 may include the LCD panel and a backlight unit 200B and may further include a display panel control IC for operation of the LCD panel, a graphic control IC, and other circuits.

FIG. 3a is a cross sectional view of the exemplary electrode sheet type pressure sensor including a pressure electrode according to an embodiment of the present invention. For example, the pressure sensor 440 may include electrode layers 450 and 460 between a first insulation layer 470 and a second insulation layer 471. The electrode layers 450 and 460 may include a first electrode 450 and/or a second electrode 460. Here, the first insulation layer 470 and the second insulation layer 471 may be made of an insulating material such as a polyimide. The first electrode 450 and the second electrode 460 may include a material like copper. In accordance with the manufacturing process of the pressure sensor 440, the electrode layers 450 and 460 and the second insulation layer 471 may be adhered to each other by means of an adhesive (not shown) like an optically clear adhesive (OCA). Also, according to the embodiment, the pressure electrodes 450 and 460 may be formed by positioning a mask, which has a through-hole corresponding to a pressure electrode pattern, on the first insulation layer 470, and then by spraying a conductive material.

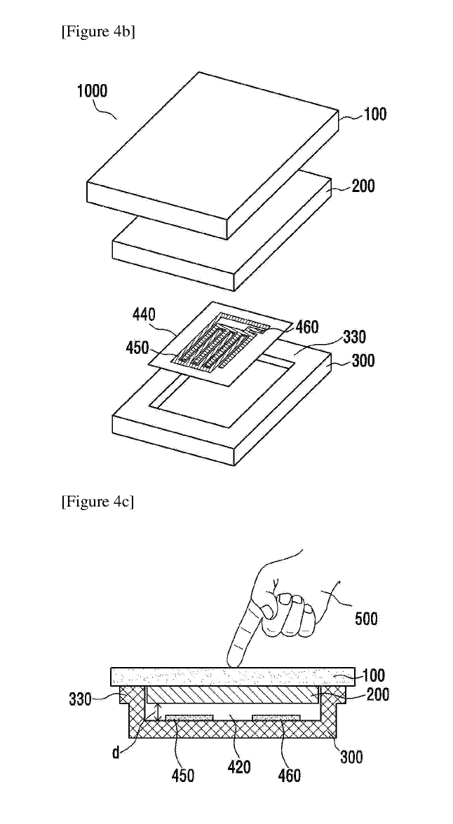

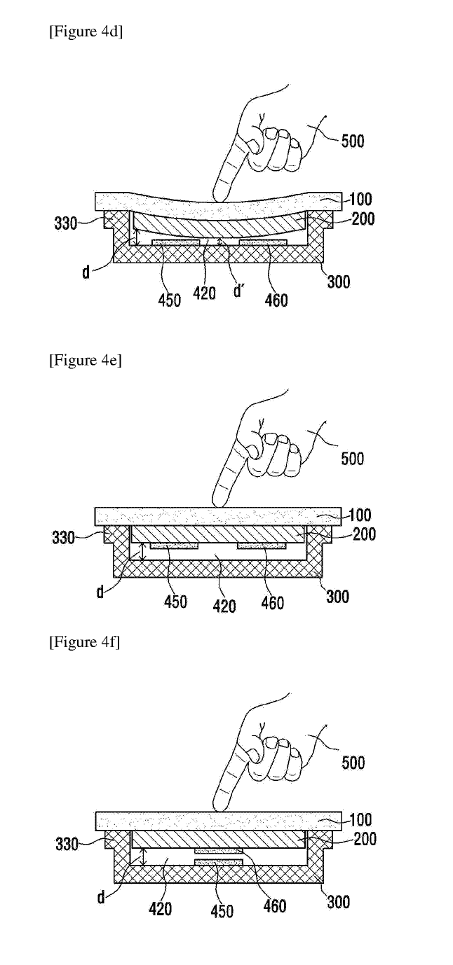

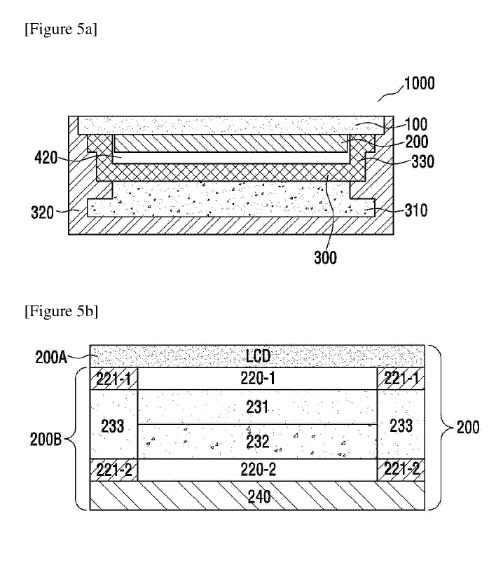

FIGS. 4a to 4f show a first example in which the electrode sheet type pressure sensor according to the embodiment of the present invention is applied to the touch input device.

In the touch input device 1000 according to the first example of the present invention, lamination may occur by an adhesive like the optically clear adhesive (OCA) between a cover layer 100 and the display module 200, where the touch sensor for detecting the touch position is formed. As a result, the display color clarity, visibility and optical transmittance of the display module 200, which can be recognized through the touch surface of the touch sensor, can be improved.

In the description with reference to FIGS. 4a to 4f, it is shown that as the touch input device 1000 according to the first example of the present invention, the cover layer 100 in which the touch sensor has been formed is laminated on and attached to the display module 200 by means of an adhesive. However, the touch input device 1000 according to the first example of the present invention may include that the touch sensor is disposed within the display module 200 shown in FIGS. 2a, 2b, etc. More specifically, while FIGS. 4a to 4b show that the cover layer 100 where the touch sensor has been formed covers the display module 200, the touch input device 1000 which includes the touch sensor disposed inside the display module 200 and includes the display module 200 covered with the cover layer like glass may be used as the first example of the present invention.

The touch input device 1000 to which the electrode sheet type pressure sensor can be applied according to the embodiment of the present invention may include an electronic device including the touch screen, for example, a cell phone, a personal data assistant (PDA), a smart phone, a tablet personal computer, an MP3 player, a laptop computer, etc.

In the touch input device 1000 to which the electrode sheet type pressure sensor can be applied according to the embodiment of the present invention, the substrate 300, together with an outermost housing 320 of the touch input device 1000, may function to surround a mounting space 310, etc., where the circuit board and/or battery for operation of the touch input device 1000 are placed. Here, the circuit board for operation of the touch input device 1000 may be a main board. A central processing unit (CPU), an application processor (AP) or the like may be mounted on the circuit board. Due to the substrate 300, the display module 200 is separated from the circuit board and/or battery for operation of the touch input device 1000. Due to the substrate 300, electrical noise generated from the display module 200 can be blocked.

The touch sensor or the front cover layer 100 of the touch input device 1000 may be formed wider than the display module 200, the substrate 300, and the mounting space 310. As a result, the housing 320 may be formed such that the housing 320, together with the touch sensor panel 100, surrounds the display module 200, the substrate 300, and the circuit board.

The touch input device 1000 according to the first example of the present invention can detect the touch position through the touch sensor and can detect the touch pressure by disposing the pressure sensor 440 between the display module 200 and the substrate 300. Here, the touch sensor may be disposed inside or outside the display module 200.

Hereinafter, the components which include the pressure sensor 440 and are for detecting the pressure are collectively referred to as a pressure detection module 400. For example, the pressure detection module 400 in the first example may include the pressure sensor 440 and/or a spacer layer 420.

As described above, for example, the pressure detection module 400 may include the spacer layer 420 composed of an air gap. This will be described in detail with reference to FIGS. 4b to 4f. According to the embodiment, the spacer layer 420 may be made of an impact absorbing material. According to the embodiment, the spacer layer 420 may be filled with a dielectric material.

FIG. 4b is a perspective view of the touch input device 1000 according to the first example of the present invention. As shown in FIG. 4b, in the first example of the present invention, the pressure sensor 440 may be disposed between the display module 200 and the substrate 300 in the touch input device 1000. Here, the touch input device 1000 may include the spacer layer which leaves a space between the display module 200 and the substrate 300 in order to dispose the pressure sensor 440.

Hereinafter, for the purpose of clearly distinguishing the electrodes 450 and 460 from the electrode included in the touch sensor, the electrodes 450 and 460 for detecting the pressure are designated as pressure electrodes 450 and 460. Here, since the pressure electrodes 450 and 460 are included in the rear side instead of in the front side of the display panel, the pressure electrodes 450 and 460 may be made of an opaque material as well as a transparent material.

Here, a frame 330 having a predetermined height may be formed along the border of the upper portion of the substrate 300 in order to maintain the spacer layer 420 in which the pressure sensor 440 is disposed. Here, the frame 330 may be bonded to the cover layer 100 by means of an adhesive tape (not shown). While FIG. 4b shows the frame 330 is formed on the entire border (e.g., four sides of the quadrangle) of the substrate 300, the frame 330 may be formed only on at least some (e.g., three sides of the quadrangle) of the border of the substrate 300. According to the embodiment, the frame 330 may be formed on the top surface of the substrate 300 and may be integrally formed with the substrate 300. In the embodiment of the present invention, the frame 330 may be made of an inelastic material. In the embodiment of the present invention, when pressure is applied to the display module 200 through the cover layer 100, the display module 200, together with the cover layer 100, may be bent. Therefore, the magnitude of the touch pressure can be detected even though the frame 330 is not transformed by the pressure.

FIG. 4c is a cross sectional view of the touch input device including the pressure electrode of the electrode sheet according to the embodiment of the present invention. While FIG. 4c and some of the following figures show that the pressure electrodes 450 and 460 are separated from the pressure sensor 440, this is only for convenience of description. The pressure electrodes 450 and 460 may be included in the pressure sensor 440. As shown in FIG. 4c, the pressure sensor 440 including the pressure electrodes 450 and 460 according to the embodiment of the present invention may be disposed within the spacer layer 420 and on the substrate 300.

The pressure electrode for detecting the pressure may include the first electrode 450 and the second electrode 460. Here, any one of the first and the second electrodes 450 and 460 may be a drive electrode and the other may be a receiving electrode. A drive signal is applied to the drive electrode, and a sensing signal may be obtained through the receiving electrode. When voltage is applied, the mutual capacitance may be generated between the first electrode 450 and the second electrode 460.

FIG. 4d is a cross sectional view when pressure is applied to the touch input device 1000 shown in FIG. 4c. The bottom surface of the display module 200 may have a ground potential so as to block the noise. When the pressure is applied to the surface of the cover layer 100 by an object 500, the cover layer 100 and the display module 200 may be bent or pressed. As a result, a distance “d ” between the ground potential surface and the pressure electrode 450 and 460 may be decreased to “d′ ”. In this case, due to the decrease of the distance “d”, the fringing capacitance is absorbed in the bottom surface of the display module 200, so that the mutual capacitance between the first electrode 450 and the second electrode 460 may be reduced. Therefore, the magnitude of the touch pressure can be calculated by obtaining the reduction amount of the mutual capacitance from the sensing signal obtained through the receiving electrode.

Although it has been described in FIG. 4d that the bottom surface of the display module 200 has a ground potential, that is to say, is a reference potential layer, the reference potential layer may be disposed within the display module 200. Here, when pressure is applied to the surface of the cover layer 100 by the object 500, the cover layer 100 and the display module 200 may be bent or pressed. As a result, a distance between the pressure electrodes 450 and 460 and the reference potential layer disposed within the display module 200 is changed. Therefore, the magnitude of the touch pressure can be calculated by obtaining the capacitance change amount from the sensing signal obtained through the receiving electrode.

Meanwhile, in FIGS. 4c and 4d, the first electrode 450 and the second electrode 460 may be not only the drive electrode but also the receiving electrode. In this case, the sensing signal may be output from the first electrode 450 and the second electrode 460 while the drive signal is applied to the first electrode 450 and the second electrode 460. The application of the drive signal to the first electrode 450 and the second electrode 460 and the output of the sensing signal from the first electrode 450 and the second electrode 460 may be performed at the same time. The self-capacitance change amount between the reference potential layer of the display module 200 and the first and second electrodes 450 and 460 is obtained from the sensing signal output from the first and second electrodes 450 and 460, so that the magnitude of the touch pressure can be calculated.

In the touch input device 1000 to which the pressure sensor 440 is applied according to the embodiment of the present invention, the display module 200 may be bent or pressed by the touch pressure. The display module 200 may be bent or pressed in such a manner as to show the transformation caused by the touch. When the display module 200 is bent or pressed according to the embodiment, a position showing the biggest transformation may not match the touch position. However, the display module 200 may be shown to be bent at least at the touch position. For example, when the touch position approaches close to the border, edge, etc., of the display module 200, the most bent or pressed position of the display module 200 may not match the touch position, however, the display module 200 may be shown to be bent or pressed at least at the touch position.

Here, the top surface of the substrate 300 may also have the ground potential in order to block the noise. FIG. 9 shows a cross section of the electrode sheet according to the embodiment of the present invention. Referring to (a) of FIG. 9, a cross section when the pressure sensor 440 including the pressure electrodes 450 and 460 is attached to the substrate 300 or the display module 200 is shown in (a) of FIG. 9. Here, in the pressure sensor 440, since the pressure electrodes 450 and 460 are disposed between the first insulation layer 470 and the second insulation layer 471, a short-circuit can be prevented from occurring between the pressure electrodes 450 and 460 and either the substrate 300 or the display module 200. Also, depending on the kind and/or implementation method of the touch input device 1000, the substrate 300 or the display module 200 on which the pressure electrodes 450 and 460 are attached may not have the ground potential or may have a weak ground potential. In this case, the touch input device 1000 according to the embodiment of the present may further include a ground electrode (not shown) between the first insulation layer 470 and either the substrate 300 or the display module 200. According to the embodiment, another insulation layer (not shown) may be included between the ground electrode and either the substrate 300 or the display module 200. Here, the ground electrode (not shown) is able to prevent the size of the capacitance generated between the first electrode 450 and the second electrode 460, which are pressure electrodes, from increasing excessively.

FIG. 4e shows that the pressure sensor 440 including the pressure electrodes 450 and 460 according to the embodiment of the present invention is formed on the bottom surface of the display module 200. Here, the substrate 300 may have the ground potential. Therefore, a distance “d” between the substrate 300 and the pressure electrodes 450 and 460 is reduced by touching the touch surface of the cover layer 100. Consequently, this may cause the change of the mutual capacitance or the self-capacitance between the first electrode 450 and the second electrode 460.

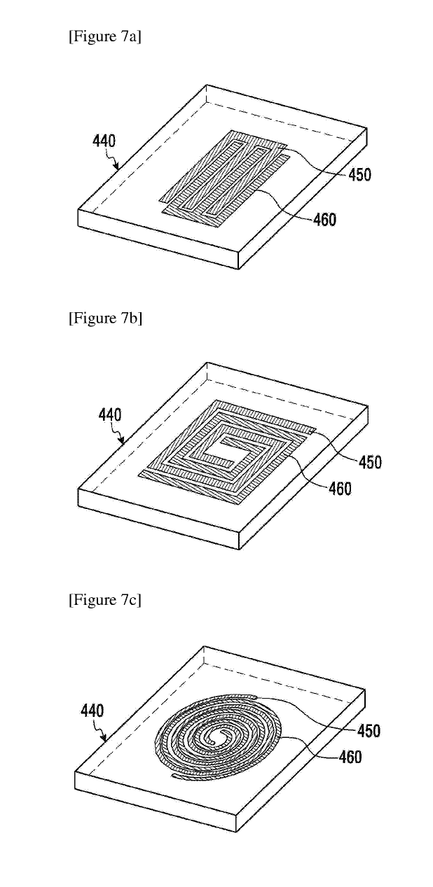

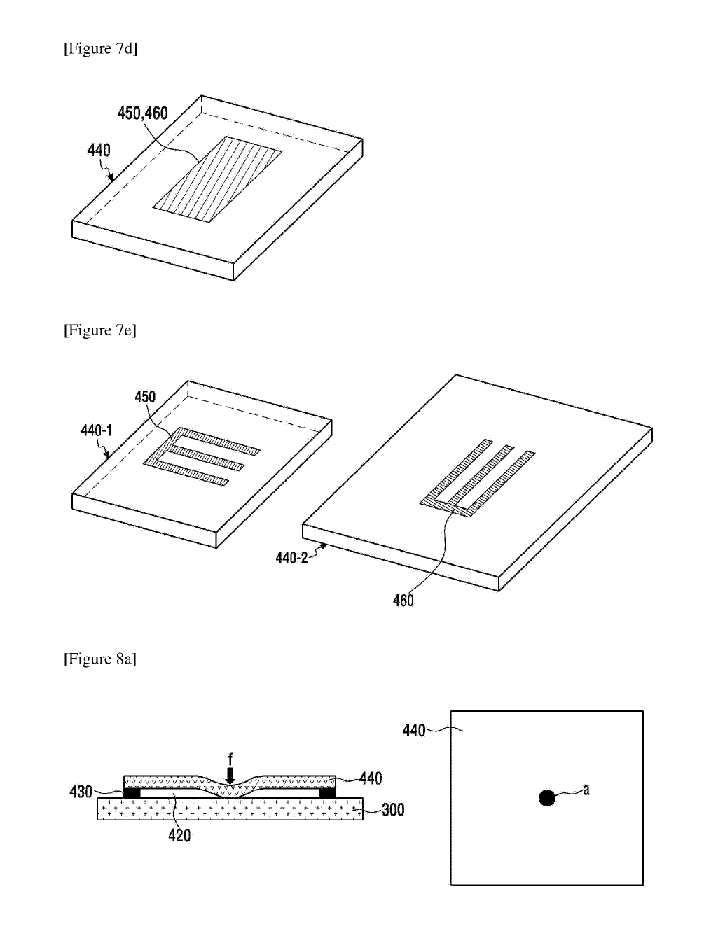

FIGS. 7a to 7e show pressure electrode patterns included in the pressure sensor for detecting a pressure in accordance with the embodiment of the present invention. FIGS. 7a to 7c show the patterns of the first electrode 450 and the second electrode 460 included in the pressure sensor 440. The pressure sensor 440 including the pressure electrode patterns shown in FIGS. 7a to 7c may be formed on the substrate 300 or on the bottom surface of the display module 200. The capacitance between the first electrode 450 and the second electrode 460 may be changed depending on a distance between a reference potential layer (display module 200 or substrate 300) and the electrode layer including both the first electrode 450 and the second electrode 460.

When the magnitude of the touch pressure is detected as the mutual capacitance between the first electrode 450 and the second electrode 460 is changed, it is necessary to form the patterns of the first electrode 450 and the second electrode 460 so as to generate the range of the capacitance required to improve the detection accuracy. With the increase of a facing area or facing length of the first electrode 450 and the second electrode 460, the size of the capacitance that is generated may become larger. Therefore, the pattern can be designed by adjusting the size of the facing area, facing length and facing shape of the first electrode 450 and the second electrode 460 in accordance with the range of the necessary capacitance. FIGS. 7b and 7c show that the first electrode 450 and the second electrode 460 are formed in the same layer, and show that the pressure electrode is formed such that the facing length of the first electrode 450 and the second electrode 460 becomes relatively longer.

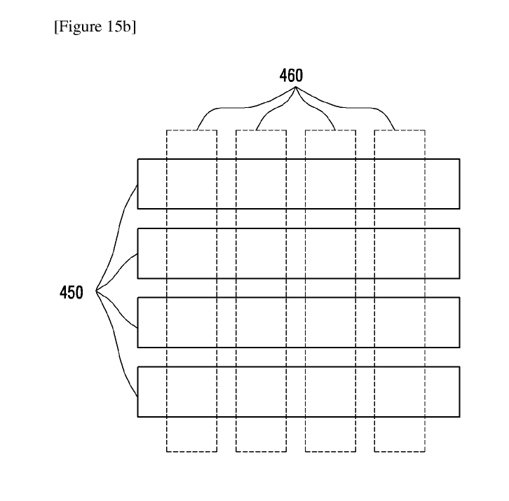

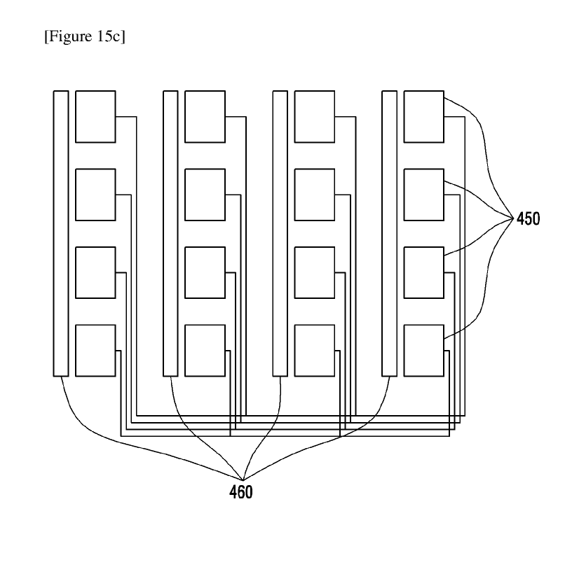

As such, in the state where the first electrode 450 and the second electrode 460 are formed in the same layer, each of the first electrode 450 and the second electrode 460 shown in (a) of FIG. 9 may be, as shown in FIG. 15a, composed of a plurality of lozenge-shaped electrodes. Here, the plurality of the first electrodes 450 are connected to each other in a first axial direction, and the plurality of the second electrodes 460 are connected to each other in a second axial direction orthogonal to the first axial direction. The lozenge-shaped electrodes of at least one of the first and the second electrodes 450 and 460 are connected to each other through a bridge, so that the first electrode 450 and the second electrode 460 may be insulated from each other. Also, here, the first electrode 450 and the second electrode 460 shown in (a) of FIG. 9 may be composed of an electrode having a form shown in FIG. 15b.

It can be considered that the first electrode 450 and the second electrode 460 are formed in different layers in accordance with the embodiment and form the electrode layer. A cross section when the first electrode 450 and the second electrode 460 are formed in different layers is shown in (b) of FIG. 9. As shown in (b) of FIG. 9, the first electrode 450 may be formed on the first insulation layer 470, and the second electrode 460 may be formed on the second insulation layer 471 positioned on the first electrode 450. According to the embodiment, the second electrode 460 may be covered with a third insulation layer 472. In other words, the pressure sensor 440 may include the first to the third insulation layers 470 to 472, the first electrode 450, and the second electrode 460. Here, since the first electrode 450 and the second electrode 460 are disposed in different layers, they can be implemented so as to overlap each other. For example, the first electrode 450 and the second electrode 460 may be, as shown in FIG. 15c, formed similarly to the pattern of the drive electrode TX and receiving electrode RX which are arranged in the form of M×N array. Here, M and N may be natural numbers greater than 1. Also, as shown in FIG. 15c, the lozenge-shaped first and the second electrodes 450 and 460 may be disposed in different layers respectively.

In the foregoing, it is shown that the touch pressure is detected from the change of the mutual capacitance between the first electrode 450 and the second electrode 460. However, the pressure sensor 440 may be configured to include only any one of the first electrode 450 and the second electrode 460. In this case, it is possible to detect the magnitude of the touch pressure by detecting the change of the capacitance between the one pressure electrode and a ground layer (the display module 200, the substrate 300, or the reference potential layer disposed within the display module 200), that is to say, the self-capacitance. Here, the drive signal is applied to the one pressure electrode, and the change of the self-capacitance between the pressure electrode and the ground layer can be detected by the pressure electrode.

For instance, in FIG. 4c, the pressure electrode included in the pressure sensor 440 may be configured to include only the first electrode 450. Here, the magnitude of the touch pressure can be detected by the change of the self-capacitance between the first electrode 450 and the display module 200, which is caused by a distance change between the display module 200 and the first electrode 450. Since the distance “d” is reduced with the increase of the touch pressure, the capacitance between the display module 200 and the first electrode 450 may be increased with the increase of the touch pressure. This can be applied in the same manner to the embodiment related to FIG. 4e. Here, the pressure electrode should not necessary have a comb teeth shape or a trident shape, which is required to improve the detection accuracy of the mutual capacitance change amount. The pressure electrode may have, as shown in FIG. 7d, a plate shape (e.g., quadrangular plate).

A cross section when the pressure sensor 440 is formed to include only the first electrode 450 is shown in (c) of FIG. 9. As shown in (c) of FIG. 9, the pressure sensor 440 including the first electrode 450 may be disposed on the substrate 300 or on the display module 200.

FIG. 4f shows that the pressure electrodes 450 and 460 are formed within the spacer layer 420 and on the top surface of the substrate 300 and on the bottom surface of the display module 200. The electrode sheet may include a first pressure sensor 440-1 including the first electrode 450 and a second pressure sensor 440-2 including the second electrode 460. Here, any one of the first electrode 450 and the second electrode 460 may be formed on the substrate 300, and the other may be formed on the bottom surface of the display module 200. FIG. 4f shows that the first electrode 450 is formed on the substrate 300, and the second electrode 460 is formed on the bottom surface of the display module 200.

When the pressure is applied to the surface of the cover layer 100 by the object 500, the cover layer 100 and the display module 200 may be bent or pressed. As a result, a distance “d” between the first electrode 450 and the second electrode 460 may be reduced. In this case, the mutual capacitance between the first electrode 450 and the second electrode 460 may be increased with the reduction of the distance “d”. Therefore, the magnitude of the touch pressure can be calculated by obtaining the increase amount of the mutual capacitance from the sensing signal obtained through the receiving electrode. Here, the patterns of the first electrode 450 and the second electrode 460 may have a shape as shown in FIG. 7d respectively. That is, since the first electrode 450 and the second electrode 460 are formed in different layers in FIG. 4f, the first electrode 450 and the second electrode 460 should not necessary have a comb teeth shape or a trident shape, and may have a plate shape (e.g., quadrangular plate).

A cross section when the first pressure sensor 440-1 including the first electrode 450 is attached to the substrate 300 and the second pressure sensor 440-2 including the second electrode 460 is attached to the display module 200 is shown in (d) of FIG. 9. As shown in (d) of FIG. 9, the first pressure sensor 440-1 including the first electrode 450 may be disposed on the substrate 300. Also, the second pressure sensor 440-2 including the second electrode 460 may be disposed on the bottom surface of the display module 200.

As with the description related to (a) of FIG. 9, when substrate 300 or the display module 200 on which the pressure electrodes 450 and 460 are attached may not have the ground potential or may have a weak ground potential, the pressure sensor 440 may further include, as shown in (a) to (d) of FIG. 9, a ground electrode (not shown) between the first insulation layers 470, 470-1, and 470-2 and the substrate 300 or the display module 200. Here, the pressure sensor 440 may further include an additional insulation layer (not shown) between the ground electrode (not shown) and the substrate 300 or the display module 200.

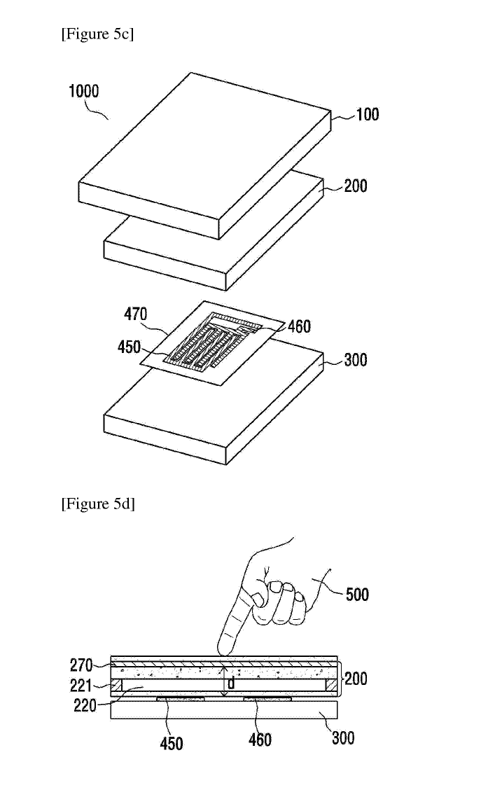

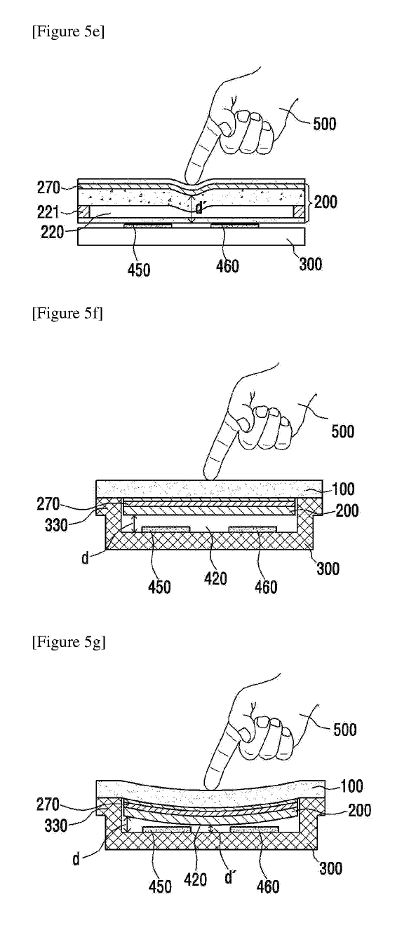

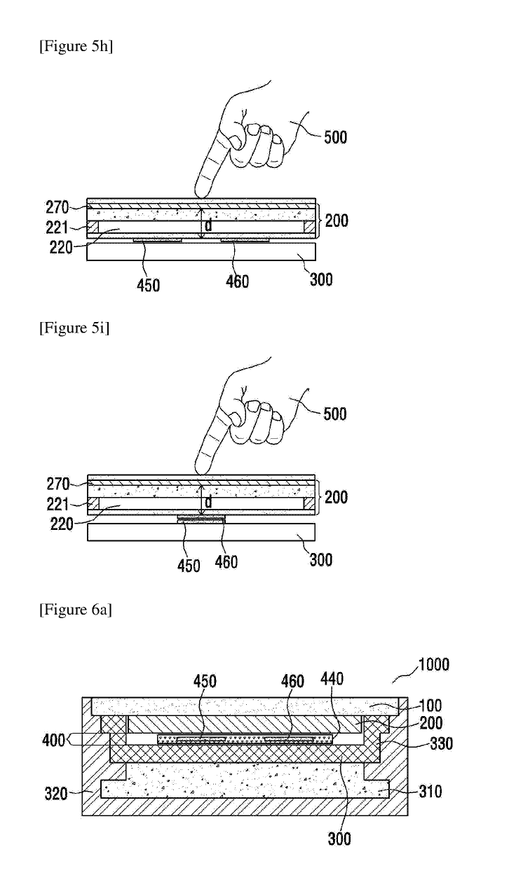

FIGS. 5a to 5i show a second example in which the electrode sheet according to the embodiment of the present invention is applied to the touch input device. The second example of the present invention is similar to the first example described with reference to FIGS. 4a to 4f. Hereafter, the following description will focus on differences between the first and second examples.

FIG. 5a is a cross sectional view of the touch input device in which the pressure sensor 440 has been disposed according to the second example.

In the touch input device 1000 according to the second example of the present invention, the touch pressure can be detected by using the air gap and/or potential layer which are positioned inside or outside the display module 200 without manufacturing a separate spacer layer and/or reference potential layer. This will be described in detail with reference to FIGS. 5b to 5i.

FIG. 5b is an exemplary cross sectional view of the display module 200 which can be included in the touch input device 1000 according to the second example of the present invention. FIG. 5b shows an LCD module as the display module 200. As shown in FIG. 5b, the display module 200 that is an LCD module may include the backlight unit 200B and the display panel 200A that is an LCD panel. The LCD panel cannot emit light in itself and simply performs a function of blocking or transmitting the light. Therefore, a light source is positioned below the LCD panel 200A and light is illuminated onto the LCD panel, so that a screen displays not only brightness and darkness but information with various colors. Since the LCD panel is a passive device and cannot emit the light in itself, a light source having a uniform luminance distribution is required on the rear side. The structures and functions of the LCD panel and the backlight unit have been already known to the public and will be briefly described below.

The backlight unit 200B for the LCD panel may include several optical parts. In FIG. 5b, the backlight unit 200B may include a light diffusing and light enhancing sheet 231, a light guide plate 232, and a reflection plate 240. Here, the backlight unit 200B may include a light source (not shown) which is formed in the form of a linear light source or point light source and is disposed on the rear and/or side of the light guide plate 232. According to the embodiment, a support 233 may be further included on the edges of the light guide plate 232 and the light diffusing and light enhancing sheet 231.

The light guide plate 232 may generally convert lights from the light source (not shown) in the form of a linear light source or point light source into light from a light source in the form of a surface light source, and allow the light to proceed to the LCD panel.

A part of the light emitted from the light guide plate 232 may be emitted to a side opposite to the LCD panel and be lost. The reflection plate 240 may be positioned below the light guide plate 232 so as to cause the lost light to be incident again on the light guide plate 232, and may be made of a material having a high reflectance.

The light diffusing and light enhancing sheet 231 may include a diffuser sheet and/or a prism sheet. The diffuser sheet functions to diffuse the light incident from the light guide plate 232. For example, light scattered by the pattern of the light guide plate 232 comes directly into the eyes of the user, and thus, the pattern of the light guide plate 232 may be shown as it is. Moreover, since such a pattern can be clearly sensed even after the LCD panel is mounted, the diffuser sheet is able to perform a function to offset the pattern of the light guide plate 232.

After the light passes through the diffuser sheet, the luminance of the light is rapidly reduced. Therefore, the prism sheet may be included in order to improve the luminance of the light by focusing the light again.

The backlight unit 200B may include a configuration different from the above-described configuration in accordance with the technical change and development and/or the embodiment. The backlight unit 200B may further include an additional configuration as well as the foregoing configuration. Also, in order to protect the optical configuration of the backlight unit 200B from external impacts and contamination, etc., due to the introduction of the alien substance, the backlight unit 200B according to the embodiment of the present may further include, for example, a protection sheet on the prism sheet. The backlight unit 200B may also further include a lamp cover in accordance with the embodiment so as to minimize the optical loss of the light source. The backlight unit 200B may also further include a frame which maintains a shape enabling the light diffusing and light enhancing sheet 231, the light guide plate 232, a lamp (not shown), and the like, which are main components of the backlight unit 200B, to be exactly combined together in accordance with an allowed dimension. Also, the each of the components may be comprised of at least two separate parts. For example, the prism sheet may include two prism sheets.

Here, a first air gap 220-2 may be positioned between the light guide plate 232 and the reflection plate 240. As a result, the lost light from the light guide plate 232 to the reflection plate 240 can be incident again on the light guide plate 232 by the reflection plate 240. Here, between the light guide plate 232 and the reflection plate 240, for the purpose of maintaining the first air gap 220-2, a display module frame 221-2 may be included on the edges of the light guide plate 232 and the reflection plate 240.

Also, according to the embodiment, the backlight unit 200B and the LCD panel may be positioned with the second air gap 220-1 placed therebetween. This intends to prevent that the impact from the LCD panel is transmitted to the backlight unit 200B. Here, between the backlight unit 200B and the LCD panel 200A, a display module frame 221-1 may be included between the LCD panel and the backlight unit 200B and on the edges of the LCD panel and the backlight unit 200B so as to maintain the second air gap 220-1.

Here, the display module frames 221-1 and 221-2 may be made of an inelastic material. In the embodiment of the present invention, when a pressure is applied to the display module 200, the display module 200 may be bent. Therefore, the magnitude of the touch pressure can be detected by the change of the distance between the light diffusing and light enhancing sheet 231 and the LCD panel or the distance between the light guide plate 232 and the reflection plate 240 even though the display module frames 221-1 and 221-2 are not deformed by the pressure.

As described above, the display module 200 may be configured to include in itself the air gap such as the first air gap 220-2 and/or the second air gap 220-1. Also, the air gap may be included between a plurality of the layers of the light diffusing and light enhancing sheet 231. In the foregoing, while the LCD module has been described, the air gap may be included within the structure of another display module.

Also, the touch input device 1000 according to the embodiment of the present invention may further include a cover (not shown) under the display module 200. The cover may be made of a metal for protecting the reflection plate 240 from contamination due to the introduction of the alien substance, external impacts, etc. In this case, the substrate 300 according to the embodiment of the present invention may be the cover. A separate cover (not shown) may be disposed between the substrate 300 and the display module 200.

Therefore, for detecting the touch pressure, the touch input device 1000 according to the second example of the present invention may make use of the air gap which has been already positioned inside or outside the display module 200 without manufacturing a separate spacer layer. The air gap which is used as the spacer layer may be not only the first air gap 220-2 and/or the second air gap 220-1 which are described with reference to FIG. 5b but also any air gap included inside the display module 200. Also, the air gap which is used as the spacer layer may be an air gap included outside the display module 200. As such, the pressure sensor 440 capable of detecting the touch pressure is inserted into the touch input device 1000, so that the manufacturing cost can be reduced and/or the manufacturing process can be simplified. FIG. 5c is a perspective view of the touch input device according to the second example of the present invention. In FIG. 5c, unlike the first example shown in FIG. 4b, the frame 330 for maintaining the spacer layer 420 may not be included.

FIG. 5d is a cross sectional view of the touch input device according to the second example. As shown in FIG. 5d, between the display module 200 and the substrate 300, the pressure sensor 440 including the pressure electrodes 450 and 460 may be formed on the substrate 300. In FIGS. 5d to 5i, the pressure electrodes 450 and 460 are shown exaggeratedly thick for convenience of description. However, since the pressure electrodes 450 and 460 can be implemented in the form of a sheet, the thickness of the first electrode 450 and the second electrode 460 may be very small. Likewise, although a distance between the display module 200 and the substrate 300 is also shown exaggeratedly large, the display module 200 and the substrate 300 may be implemented to have a very small distance therebetween. FIGS. 5d and 5e show that the display module 200 and the pressure electrodes 450 and 460 are spaced apart from each other so as to represent that the pressure sensor 440 including the pressure electrodes 450 and 460 have been formed on the substrate 300. However, this is for description only. The display module 200 and the first and second electrodes 450 and 460 may not be spaced apart from each other.

Here, FIG. 5d shows that the display module 200 includes a spacer layer 220, the display module frame 221, and a reference potential layer 270.

The spacer layer 220 may be, as described with reference to FIG. 5b, the first air gap 220-2 and/or the second air gap 220-1 which are included during the manufacture of the display module 200. When the display module 200 includes one air gap, the air gap may function as the spacer layer 220. When the display module 200 includes a plurality of air gaps, the plurality of air gaps may collectively function as the spacer layer 220. FIGS. 5d, 5e, 5h and 5i show that the display module 200 functionally includes one spacer layer 220.

According to the second example of the present invention, the touch input device 1000 may include the reference potential layer 270 which is positioned above the spacer layer 220 within the display panel 200A of FIGS. 2a to 2c. The reference potential layer 270 may be a ground potential layer which is included in itself during the manufacture of the display module 200. For example, in the display panel 200A shown in FIGS. 2a to 2b, an electrode (not shown) for blocking the noise may be included between the first polarizer layer 271 and the first substrate layer 261. The electrode for blocking the noise may be composed of ITO and may function as the ground.

Within the display module 200, the reference potential layer 270 may be located at any position causing the spacer layer 220 to be placed between the reference potential layer 270 and the pressure electrodes 450 and 460. Not only the above-described blocking electrode but also an electrode having any potential may be used as the reference potential layer 270. For example, the reference potential layer 270 may be a common electrode potential (Vcom) layer of the display module 200.

Particularly, as part of an effort to reduce the thickness of the device including the touch input device 1000, the display module 200 may not be surrounded by a separate cover or frame. In this case, the bottom surface of the display module 200, which faces the substrate 300, may be the reflection plate 240 and/or a nonconductor. In this case, the bottom surface of the display module 200 cannot have the ground potential. As mentioned, even when the bottom surface of the display module 200 cannot function as the reference potential layer, it is possible to detect the touch pressure by using any potential layer positioned within the display module 200 as the reference potential layer 270 through use of the touch input device 1000 according to the second example.

FIG. 5e is a cross sectional view of a case where a pressure has been applied to the touch input device 1000 shown in FIG. 5d. When pressure is applied to the surface of the cover layer 100 by the object 500, the cover layer 100 or the display module 200 may be bent or pressed. Here, a distance “d” between the reference potential layer 270 and the pressure electrode 450 and 460 may be decreased to “d′” by the spacer layer 220 positioned within the display module 200. In this case, due to the decrease of the distance “d”, the fringing capacitance is absorbed in the reference potential layer 270, so that the mutual capacitance between the first electrode 450 and the second electrode 460 may be reduced. Therefore, the magnitude of the touch pressure can be calculated by obtaining the reduction amount of the mutual capacitance from the sensing signal obtained through the receiving electrode.

Here, the display module frame 221 may be made of an inelastic material. In the embodiment of the present invention, when a pressure is applied to the display module 200, the display module 200 may be bent. Therefore, the magnitude of the touch pressure can be detected by the change of the distance between the reference potential layer 270 and the pressure electrodes 450 and 460 even though the display module frame 221 is not deformed by the pressure.

In the touch sensor panel 100 according to the second example of the present invention, the display module 200 may be bent or pressed by the touch pressure. Here, as shown in FIG. 5e, due to the spacer layer 220, the layer positioned below the spacer layer 220 (e.g., the reflection plate) may not be bent or pressed or may be less bent or pressed. While FIG. 5e shows that the lowest portion of the display module 200 is not bent or pressed at all, this is just an example. The lowest portion of the display module 200 may be bent or pressed. However, the degree to which the lowest portion of the display module 200 is bent or pressed can be reduced by the spacer layer 220.

Since the structure of the pressure sensor 440 including the pressure electrode according to the second example and how to attach the pressure sensor 440 are the same as those described with reference to the first example, the description thereof will be omitted.

FIG. 5f is a cross sectional view of the touch input device including the pressure electrode according to the modification of the embodiment described with reference to FIG. 5d. FIG. 5f shows that the spacer layer 220 is positioned between the display module 200 and the substrate 300. When the touch input device 1000 including the display module 200 is manufactured, the display module 200 is not completely attached to the substrate 300, so that the air gap 420 may be created. Here, by using the air gap 420 as the spacer layer for detecting the touch pressure, it is possible to reduce the time and cost required for manufacturing a separate spacer layer for detecting the touch pressure. FIGS. 5f and 5g show that the spacer layer 420, i.e., the air gap is not positioned within the display module 200. However, FIGS. 5f and 5g may additionally include a case where the spacer layer 220 is positioned within the display module 200.

FIG. 5g is a cross sectional view of a case where a pressure has been applied to the touch input device shown in FIG. 5f. As with FIG. 5d, when the touch occurs on the touch input device 1000, the display module 200 may be bent or pressed. Here, the “d” between the reference potential layer 270 and the pressure electrode 450 and 460 may be decreased to “d′” by the spacer layer 420 which is positioned between the reference potential layer 270 and the pressure electrodes 450 and 460. As a result, the magnitude of the touch pressure can be calculated by obtaining the reduction amount of the mutual capacitance from the sensing signal obtained through the receiving electrode.

Here, though not shown in FIG. 5g, a frame for maintaining the distance between the display module 200 and the substrate 300 may be formed on the edge of the display module 200 or the substrate 300. Here, the frame may be made of an inelastic material. In the embodiment of the present invention, when a pressure is applied to the display module 200, the display module 200 may be bent. Therefore, the magnitude of the touch pressure can be detected by the change of the distance between the reference potential layer 270 and the pressure electrodes 450 and 460 even though the frame is not deformed by the pressure.

FIG. 5h shows that the pressure sensor 440 including the pressure electrodes 450 and 460 is disposed on the bottom surface of the display module 200. The distance “d” between the reference potential layer 270 and the pressure electrodes 450 and 460 is reduced by touching the touch surface. Consequently, this may cause the change of the mutual capacitance between the first electrode 450 and the second electrode 460. FIG. 5h shows that the substrate 300 and the pressure electrodes 450 and 460 are spaced apart from each other so as to describe that the pressure electrodes 450 and 460 are attached on the bottom surface of the display module 200. However, this is for description only. The substrate 300 and the pressure electrodes 450 and 460 may not be spaced apart from each other. Also, as with FIGS. 5f and 5g, the display module 200 and the substrate 300 may be spaced apart from each other by the spacer layer 420.

Similarly to the first example, the pressure electrodes 450 and 460 described with reference to FIGS. 5d to 5h according to the second example may also have the pattern shown in FIGS. 7a to 7c, and repetitive descriptions thereof will be omitted.

FIG. 5i shows that the first pressure sensor 440-1 and the second pressure sensor 440-2, each of which includes the pressure electrode 450 and the pressure electrode 460 respectively, are disposed on the top surface of the substrate 300 and on the bottom surface of the display module 200 respectively. FIG. 5i shows that the first electrode 450 is formed on top surface of the substrate 300, and the second electrode 460 is formed on the bottom surface of the display module 200. FIG. 5i shows that the first electrode 450 is spaced apart from the second electrode 460. However, this is just intended to describe that the first electrode 450 is formed on the substrate 300 and the second electrode 460 is formed on the display module 200. The first electrode 450 and the second electrode 460 may be spaced apart from each other by the air gap, may have an insulating material placed therebetween, or may be formed to deviate from each other, for example, may be formed in the same layer, not to be overlapped with each other.

When pressure is applied to the surface of the cover layer 100 by the object 500, the cover layer 100 and the display module 200 may be bent or pressed. As a result, the distance “d” between the pressure electrodes 450 and 460 and the reference potential layer 270 may be reduced. In this case, the mutual capacitance between the first electrode 450 and the second electrode 460 may be reduced with the reduction of the distance “d”. Therefore, the magnitude of the touch pressure can be calculated by obtaining the reduction amount of the mutual capacitance from the sensing signal obtained through the receiving electrode. Here, the first electrode 450 and the second electrode 460 may have the pattern shown in FIG. 7e. As shown in FIG. 7e, the first electrode 450 and the second electrode 460 are disposed perpendicular to each other, so that the capacitance change amount detection sensitivity can be enhanced.

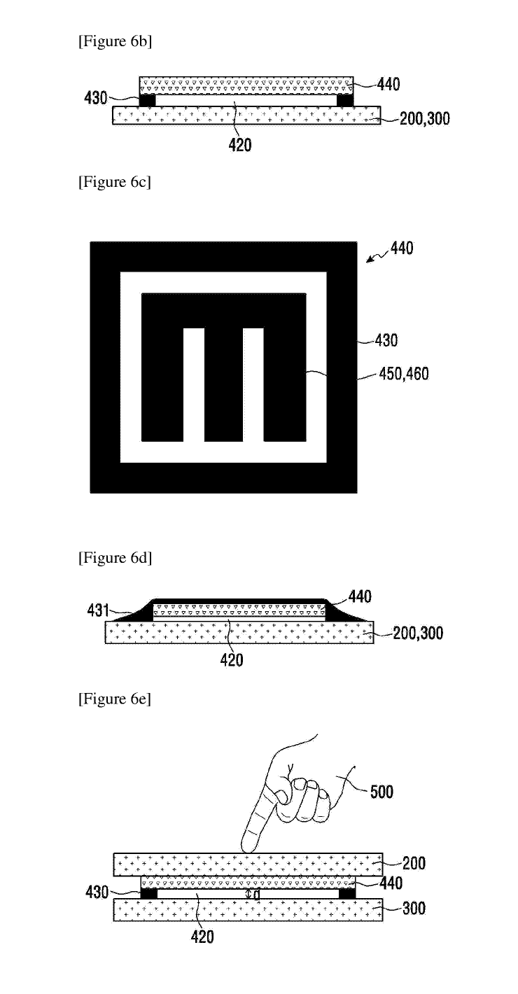

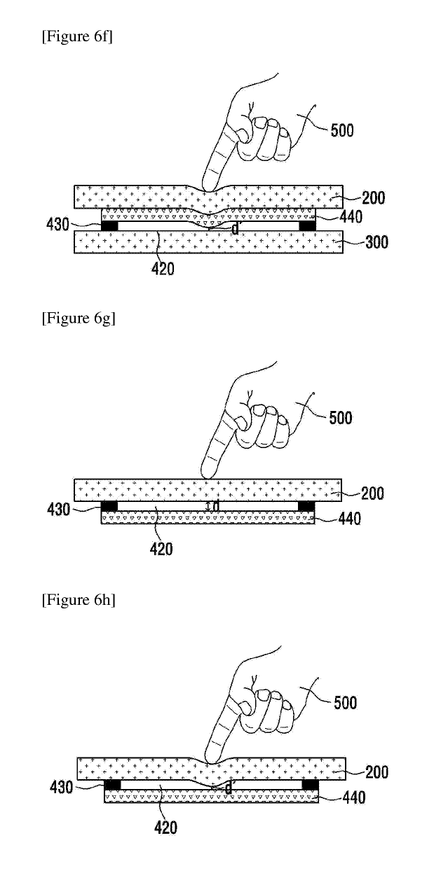

FIGS. 6a to 6h show a touch input device according to a third example of the present invention. The third example is similar to the first example. The following description will focus on differences between them.

FIG. 6a is a cross sectional view of the touch input device according to the third example of the present invention. In the third example, the pressure sensor 440 including the pressure electrodes 450 and 460 included in the pressure detection module 400 may be inserted into the touch input device 1000. Here, FIG. 6a shows that the pressure sensor 440 including the pressure electrodes 450 and 460 is disposed apart from the substrate 300 and the display module 200. However, the pressure sensor 440 including the pressure electrodes 450 and 460 may be formed to contact any one of the substrate 300 and the display module 200.

In the touch input device 1000 according to the third example of the present invention, for the purpose of detecting the touch pressure, the pressure sensor 440 may be attached to the display module 200 such that the pressure sensor 440 and either the substrate 300 or the display module 200 are spaced apart from each other with the spacer layer 420 placed therebetween.

FIG. 6b is a partial cross sectional view of the touch input device including the pressure sensor 440 attached thereto according to a first method. FIG. 6b shows that the pressure sensor 440 has been attached on the substrate 300 or the display module 200.

As shown in FIG. 6c, the frame 430 with a predetermined thickness may be formed along the border of the pressure sensor 440 in order to maintain the spacer layer 420. While FIG. 6c shows the frame 430 is formed on the entire border (e.g., four sides of the quadrangle) of the pressure sensor 440, the frame 430 may be formed only on at least some (e.g., three sides of the quadrangle) of the border of the pressure sensor 440. Here, as shown in FIG. 6c, the frame 430 may not formed in an area including the electrode patterns 450 and 460. As a result, when the pressure sensor 440 is attached to the substrate 300 of the display module 200 by the frame 430, the pressure electrodes 450 and 460 may be spaced apart from the substrate 300 of the display module 200 by a predetermined distance. According to the embodiment, the frame 430 may be formed on the top surface of the substrate 300 or on the bottom surface of the display module 200. Also, the frame 430 may be a double adhesive tape. FIG. 6c shows that the pressure sensor 440 includes only one out of the pressure electrodes 450 and 460.

FIG. 6d is a partial cross sectional view of the touch input device including the electrode sheet attached thereto according to a second method. In FIG. 6d, after the pressure sensor 440 is positioned on the substrate 300 or the display module 200, the pressure sensor 440 can be fixed to the substrate 300 or the display module 200 by means of an adhesive tape 431. For this, the adhesive tape 431 may contact at least a portion of the pressure sensor 440 and at least a portion of the substrate 300 or the display module 200. FIG. 6d shows that the adhesive tape 431 continues from the top of the pressure sensor 440 to the exposed surface of the substrate 300 or the display module 200. Here, only the surface of the adhesive tape 431, the surface contacting the pressure sensor 440, may have an adhesive strength. Accordingly, in FIG. 6d, the top surface of the adhesive tape 431 may have no adhesive strength.

As shown in FIG. 6d, even though the pressure sensor 440 is fixed to the substrate 300 or the display module 200 by the adhesive tape 431, a predetermined space, i.e., the air gap may be created between the pressure sensor 440 and either the substrate 300 or the display module 200. This is because the pressure sensor 440 is not directly attached to either the substrate 300 or the display module 200 by an adhesive and because the pressure sensor 440 includes the pressure electrodes 450 and 460 having a pattern, so that the surface of the pressure sensor 440 may not be flat. The air gap 420 of FIG. 6d may also function as the spacer layer 420 for detecting the touch pressure.

In the following description, the third example has been described with reference to a case where the pressure sensor 440 is attached t to the substrate 300 or the display module 200 by the first method shown in FIG. 6b. However, the description can be applied to a case where the pressure sensor 440 is attached and spaced from the substrate 300 or the display module 200 by any method like the second method, etc.

FIG. 6e is a cross sectional view of the touch input device including the pressure electrode pattern according to the third example of the present invention. As shown in FIG. 6e, the pressure sensor 440 including the pressure electrodes 450 and 460 may be attached to the substrate 300 such that, particularly, the area where the pressure electrodes 450 and 460 have been formed is spaced from the substrate 300 by the spacer layer 420. While FIG. 6e shows that the display module 200 contacts the pressure sensor 440, this is just an example. The display module 200 may be positioned apart from the pressure sensor 440.

FIG. 6f is a cross sectional view of a case where a pressure has been applied to the touch input device 1000 shown in FIG. 6e. The substrate 300 may have a ground potential so as to block the noise. When the pressure is applied to the surface of the cover layer 100 by the object 500, the cover layer 100 and the display module 200 may be bent or pressed. As a result, the pressure sensor 440 is pressed, so that the distance “d” between the substrate 300 and the pressure electrodes 450 and 460 included in the pressure sensor 440 may be decreased to “d′”. In this case, due to the decrease of the distance “d”, the fringing capacitance is absorbed in the substrate 300, so that the mutual capacitance between the first electrode 450 and the second electrode 460 may be reduced. Therefore, the magnitude of the touch pressure can be calculated by obtaining the reduction amount of the mutual capacitance from the sensing signal obtained through the receiving electrode.

As shown in FIGS. 6e and 6f, the touch input device 1000 according to the third example of the present invention is able to detect the touch pressure by the distance change between the pressure sensor 440 and the substrate 300 to which the pressure sensor 440 has been attached. Here, since the distance “d” between the pressure sensor 440 and the substrate 300 is very small, the touch input device 1000 is able to precisely detect the touch pressure even by the minute change in the distance “d” due to the touch pressure.

FIG. 6g shows that the pressure electrodes 450 and 460 are attached to the bottom surface of the display module 200. FIG. 6h is a cross sectional view of a case where a pressure has been applied to the touch input device shown in FIG. 6g. Here, the display module 200 may have the ground potential. Therefore, a distance “d” between the display module 200 and the pressure electrodes 450 and 460 is reduced by touching the touch surface of the touch sensor panel 100. Consequently, this may cause the change of the mutual capacitance between the first electrode 450 and the second electrode 460.

As shown in FIGS. 6g and 6h, it can be understood that the touch input device 1000 according to the third example of the present invention can also detect the touch pressure by a distance change between the pressure sensor 440 and the display module 200 to which the pressure sensor 440 has been attached.

For example, the distance between the display module 200 and the pressure sensor 440 may be less than the distance between the pressure sensor 440 and the substrate 300. Also, for example, the distance between the pressure sensor 440 and the bottom surface of the display module 200 having the ground potential may be less than the distance between the pressure sensor 440 and the Vcom potential layer and/or any ground potential layer. For example, in the display panel 200 shown in FIGS. 2a to 2c, an electrode (not shown) for blocking the noise may be included between the first polarizer layer 271 and the first glass layer 261. The electrode for blocking the noise may be composed of ITO and may function as the ground.

The first electrode 450 and the second electrode 460 which are included in FIGS. 6e to 6h may have the pattern shown in FIGS. 7a to 7c, and repetitive descriptions thereof will be omitted.

In FIGS. 6a to 6h, it is shown that the first electrode 450 and the second electrode 460 which are included in the pressure sensor 440 are formed in the same layer. However, it can be considered that the first electrode 450 and the second electrode 460 are formed in different layers in accordance with the embodiment. As shown in FIG. 9b, in the pressure sensor 440, the first electrode 450 may be formed on the first insulation layer 470, and the second electrode 460 may be formed on the second insulation layer 471 positioned on the first electrode 450. The second electrode 460 may be covered with the third insulation layer 472.

Also, according to the embodiment, the pressure electrodes 450 and 460 may be configured to include only any one of the first electrode 450 and the second electrode 460. In this case, it is possible to detect the magnitude of the touch pressure by detecting the change of the capacitance between the one pressure electrode and the ground layer (either the display module 200 or the substrate 300), that is to say, the self-capacitance. Here, the pressure electrode may have, as shown in FIG. 7d, a plate shape (e.g., quadrangular plate). Here, as shown in FIG. 9c, in the pressure sensor 440, the first electrode 450 may be formed on the first insulation layer 470 and may be covered with the third insulation layer 472.

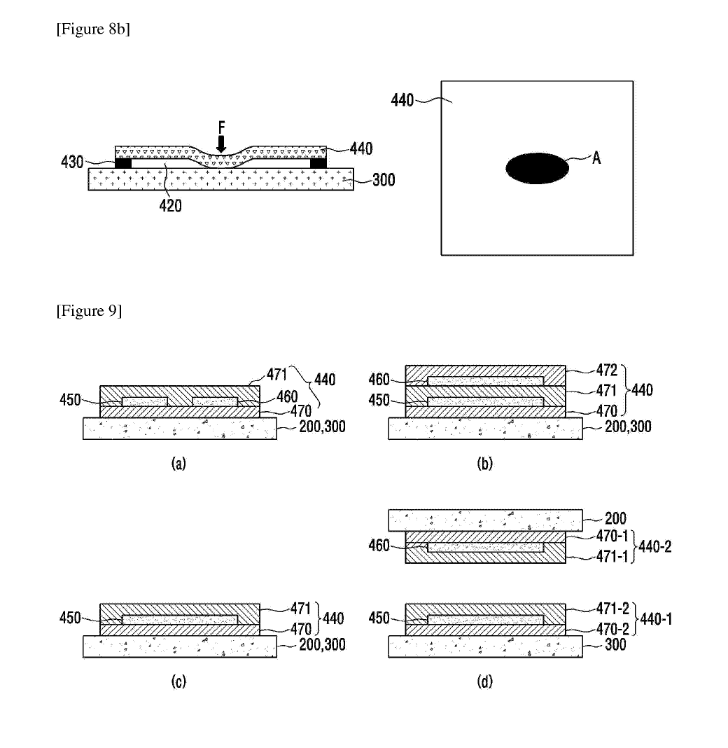

FIGS. 8a and 8b show a relation between the magnitude of the touch pressure and a saturated area in the touch input device to which the pressure sensor 440 has been applied according to the embodiment of the present invention. Although FIGS. 8a and 8b show that the pressure sensor 440 is attached to the substrate 300, the following description can be applied in the same manner to a case where the pressure sensor 440 is attached to the display module 200.

The touch pressure with a sufficient magnitude makes a state where the distance between the pressure sensor 440 and the substrate 300 cannot be reduced any more at a predetermined position. Hereafter, the state is designated as a saturation state. For instance, as shown in FIG. 8a, when the touch input device 1000 is pressed by a force “f”, the pressure sensor 440 contacts the substrate 300, and thus, the distance between the pressure sensor 440 and the substrate 300 cannot be reduced any more. Here, as shown on the right of FIG. 8a, the contact area between the pressure sensor 440 and the substrate 300 may be indicated by “a”.

However, in this case, when the magnitude of the touch pressure becomes larger, the contact area between the pressure sensor 440 and the substrate 300 in the saturation state where the distance between the pressure sensor 440 and the substrate 300 cannot be reduced any more may become greater. For example, as shown in FIG. 8b, when the touch input device 1000 is pressed by a force “F” greater than the force “f”, the contact area between the pressure sensor 440 and the substrate 300 may become greater. As shown on the right of FIG. 8a, the contact area between the pressure sensor 440 and the substrate 300 may be indicated by “A”. As such, the greater the contact area, the more the mutual capacitance between the first electrode 450 and the second electrode 460 may be reduced. Hereafter, it will be described that the magnitude of the touch pressure is calculated by the change of the capacitance according to the distance change. This may include that the magnitude of the touch pressure is calculated by the change of the saturation area in the saturation state.

FIGS. 8a and 8b are described with reference to the third example. It is apparent that the description with reference to FIGS. 8a and 8b can be applied in the same manner to the first to second examples and the following fourth example. More specifically, the magnitude of the touch pressure can be calculated by the change of the saturation area in the saturation state where the distance between the pressure electrodes 450 and 460 and either the ground layer or the reference potential layer 200, 300, and 270 cannot be reduced any more.

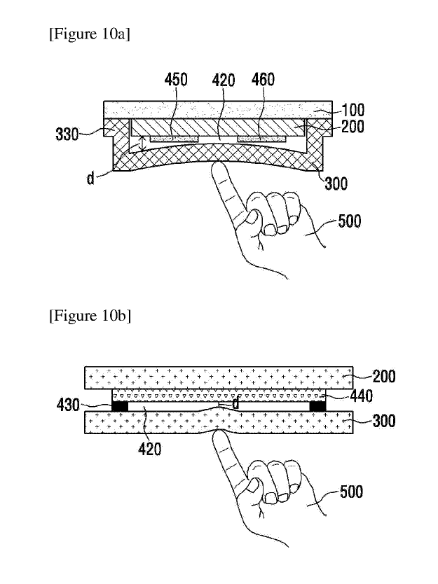

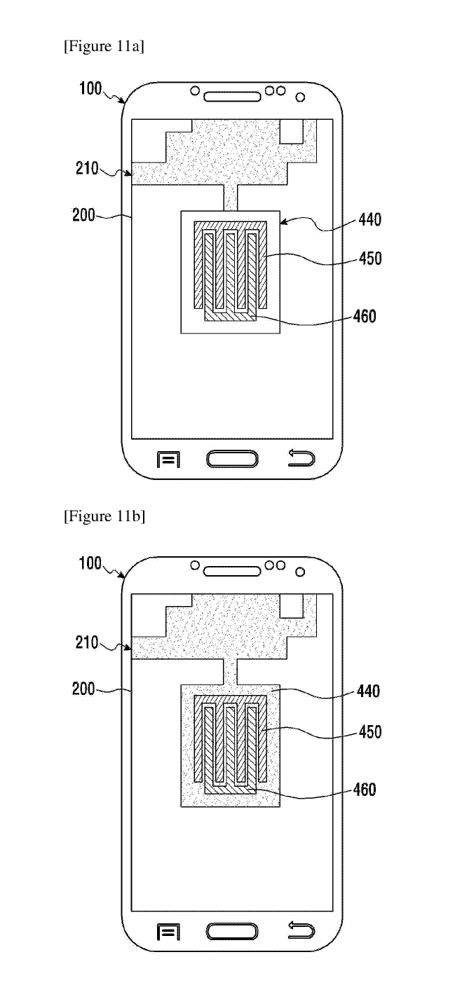

FIGS. 10a and 10b show a touch input device according to a fourth example of the present invention. The touch input device 1000 according to the fourth example of the present invention can sense the touch pressure by inserting the pressure sensor 440 even when the pressure is applied to the bottom surface as well as the top surface of the touch input device. In this specification, the top surface of the touch input device 1000 as the touch surface may be designated as the top surface of the display module 200 and may include not only the top surface of the display module 200 but also the surface of a member covering the top surface of the display module 200. Also, in this specification, the bottom surface of the touch input device 1000 as the touch surface may be designated as the bottom surface of the substrate 300 and may include not only the bottom surface of the substrate 300 but also the surface of a member covering the bottom surface of the substrate 300.

FIG. 10a shows that the pressure sensor 440 including the pressure electrodes 450 and 460 is positioned on the bottom surface of the display module 200 in the first example. FIG. 10a shows that the distance between the substrate 300 and the pressure electrodes 450 and 460 is changed when the substrate 300 is pressed or bent by applying a pressure to the bottom surface of the substrate 300. Here, as the distance between the pressure electrodes 450 and 460 and the substrate 300, i.e., the reference potential layer is changed, the capacitance between the first electrode 450 and the second electrode 460 or the capacitance between the substrate 300 and either the first electrode 450 or the second electrode 460 is changed. Accordingly, the touch pressure can be detected.

FIG. 10b shows that the pressure sensor 440 is attached to the substrate 300 in the third example. FIG. 10b shows that the distance between the substrate 300 and the pressure sensor 440 is changed when the substrate 300 is pressed or bent by applying a pressure to the bottom surface of the substrate 300. As with the case of FIG. 10a, as the distance between the pressure electrodes 450 and 460 and the substrate 300, i.e., the reference potential layer is changed, the capacitance between the first electrode 450 and the second electrode 460 or the capacitance between the substrate 300 and either the first electrode 450 or the second electrode 460 is changed. Accordingly, the touch pressure can be detected.

In FIGS. 10a and 10b, while the fourth example has been described based on the structures of some of the first and third examples, the fourth example can be applied to a case where the substrate 300 is bent or pressed by applying a pressure to the bottom surface of the substrate 300 included in the structures of the first to the third examples, so that the capacitance between the first electrode 450 and the second electrode 460 is changed or the capacitance between the first electrode 450 and the reference potential layer 200, 300, and 270 is changed. For example, in the structure shown in FIG. 4c, when the substrate 300 is bent or pressed, the distance between the display module 200 and the pressure electrodes 450 and 460 may be changed, thereby detecting the pressure.

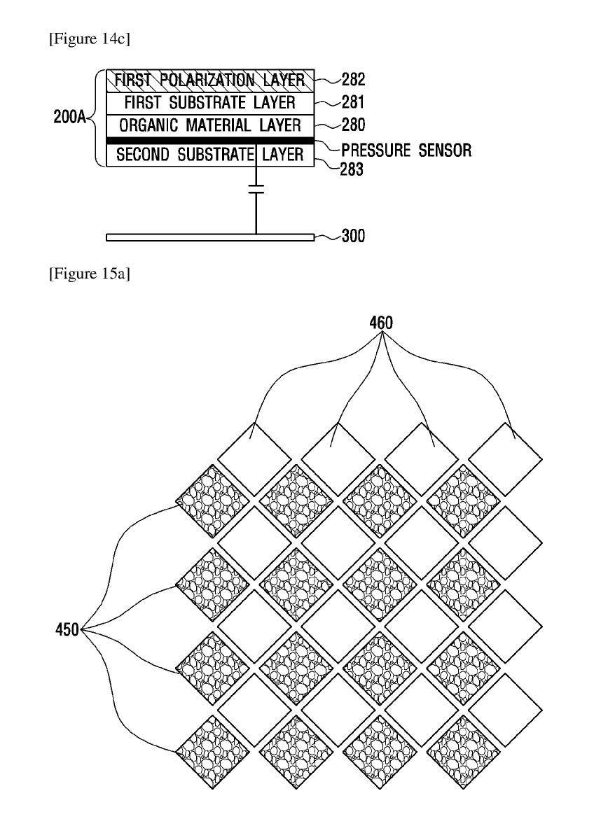

The pressure sensor according to the embodiment of the present invention may be formed directly on the display panel 200A. FIGS. 14a to 14c are cross sectional views showing an embodiment of the pressure sensor formed directly on various display panels 200A.

First, FIG. 14a shows the pressure sensor formed on the display panel 200A using the LCD panel. Specifically, as shown in FIG. 14a, the pressure sensor including the pressure electrodes 450 and 460 may be formed on the bottom surface of the second substrate layer 262. Here, while the second polarization layer 272 of FIG. 2a is omitted in FIG. 14a, the second polarization layer 272 of FIG. 2a may be disposed between the pressure sensor and a backlight unit 275 or between the pressure sensor and the second substrate layer 262.

In detecting the touch pressure on the basis of the mutual capacitance change amount when a pressure is applied to the touch input device 1000, a drive signal is applied to the drive electrode 450, and an electrical signal including information on the capacitance which is changed by the distance change between the pressure electrodes 450 and 460 and the reference potential layer separated from the pressure electrodes 450 and 460 is received from the receiving electrode 460.

Meanwhile, when the touch pressure is detected on the basis of the self-capacitance change amount, a drive signal is applied to the pressure electrodes 450 and 460, and an electrical signal including information on the capacitance which is changed by the distance change between the pressure electrodes 450 and 460 and the reference potential layer separated from the pressure electrodes 450 and 460 is received from the pressure electrodes 450 and 460. Here, the reference potential layer may be the substrate 300 or may be the cover which is disposed between the display panel 200A and the substrate 300 and performs a function of protecting the display panel 200A.

Next, FIG. 14b shows the pressure sensor formed on the bottom surface of the display panel 200A using the OLED panel (in particular, AM-OLED panel). Specifically, the pressure sensor including the pressure electrodes 450 and 460 may be formed on the bottom surface of the second substrate layer 283. Here, a method for detecting the pressure is the same as that described in FIG. 14a.

Next, FIG. 14c shows the pressure sensor formed within the display panel 200A using the OLED panel. Specifically, the pressure sensor including the pressure electrodes 450 and 460 may be formed on the top surface of the second substrate layer 283. Here, a method for detecting the pressure is the same as that described in FIG. 14a.

Also, although the display panel 200A using the OLED panel has been described by taking an example thereof with reference to FIG. 14c, it is possible that the pressure electrodes 450 and 460 are formed on the top surface of the second substrate layer 283 of the display panel 200A using the LCD panel.

Also, although it has been described in FIGS. 14a to 14c that the pressure sensor including the pressure electrodes 450 and 460 is formed on the top surfaces or bottom surfaces of the second substrate layers 262 and 283, it is possible that the pressure sensor is formed on the top surfaces or bottom surfaces of the first substrate layers 261 and 281.

Also, it has been described in FIGS. 14a to 14c that the pressure sensor including the pressure electrodes 450 and 460 is directly formed on the display panel 200A. However, the pressure sensor may be directly formed on the substrate 300, and the potential layer may be the display panel 200A or may be the cover which is disposed between the display panel 200A and the substrate 300 and performs a function of protecting the display panel 200A.

Also, although it has been described in FIGS. 14a to 14c that the reference potential layer is disposed below the pressure sensor, the reference potential layer may be disposed within the display panel 200A. Specifically, the reference potential layer may be disposed on the top surface or bottom surface of the first substrate layers 261 and 281 of the display panel 200A or may be disposed on the top surface or bottom surface of the second substrate layers 262 and 283.

In the touch input device 1000 according to the embodiment of the present invention, the pressure sensor for sensing the capacitance change amount may be composed of the first electrode 450 which is directly formed on the display panel 200A and the second electrode 460 which is configured in the form of an electrode sheet. Specifically, the first electrode 450 may be, as described in FIGS. 14a to 14c, directly formed on the display panel 200A, and second electrode 460 may be, as described in FIGS. 4 to 5, configured in the form of an electrode sheet and may be attached to the touch input device 1000.

In the state where the pressure sensor in the form of the pressure sensor 440 according to the embodiment of the present invention has been, as shown in FIGS. 4 to 10, attached to the touch input device, or in the state where the pressure sensor has been, as shown in FIG. 14, formed directly on the touch input device, the magnitude of the touch pressure is detected from change amount of the capacitance detected from the pressure electrodes 450 and 460. Here, since the capacitance detected from the pressure electrodes 450 and 460 is changed by the change of ambient environment including display noise as well as by the distance change between the pressure electrodes 450 and 460 and the reference potential layer, the accuracy of the capacitance becomes poor. Particularly, when the pressure sensor is, as shown in FIGS. 14a to 14c, formed directly on the touch input device, the distance between the pressure sensor and the drive unit (e.g., pixel electrode or drive electrode) of the display panel 200A becomes small. Therefore, as the display module is driven, a parasitic capacitance between the pressure electrodes 450 and 460 and the drive unit of the display panel 200A may be included in the capacitance detected from the pressure electrodes 450 and 460. Accordingly, only when the parasitic capacitance in the change amount of the detected capacitance is significantly reduced or removed, the magnitude of the touch pressure based on the capacitance change amount due to the distance change between the pressure electrodes 450 and 460 and the reference potential layer can be accurately detected.

For this, a reset process can be intended to be repeatedly performed whenever a scan in which the drive signal Tx is applied to the pressure electrodes 450 and 460 and the sensing signal Rx is received from the pressure electrodes 450 and 460 is performed, or in a predetermined cycle. The reset process resets a reference capacitance to a reset time. This reset process is loaded on the touch sensing IC in the form of software and is carried out. Since the reset process should be carried out at a time different from a drive signal application time interval and a sensing signal reception time interval which are for detecting the touch pressure, the efficiency of the touch pressure detection may be deteriorated. Also, when input touch is maintained without being released, the reset process is not carried out during the period during which the input touch is maintained. Therefore, the capacitance change due to the display noise during the period during which the input touch is maintained cannot be excluded.

Also, even though the reference capacitance is reset to the reset time through the above-described reset process, pressure detection is performed within the time period during which the display module is driven. Therefore, it is practically impossible to exclude the capacitance change due to the display noise occurring in real time. Accordingly, there is a demand for a method for significantly reducing or removing the parasitic capacitance between the pressure electrodes 450 and 460 and the drive unit of the display module in the change amount of the capacitance detected from the pressure electrodes 450 and 460.

FIG. 3b is a cross sectional view of the touch input device according to a first example, which is for describing the method for significantly reducing or removing the parasitic capacitance formed between the display module 200 and the pressure electrodes 450 and 460 in the change amount of the capacitance detected from the pressure electrodes 450 and 460.

Referring to FIG. 3b, the touch input device according to the embodiment of the present invention may include the display module 200, the pressure electrodes 450 and 460, and the substrate 300.

The display module 200 may include a display panel. The display panel may be the display panel 200A shown in FIG. 2a or 2b.

The display panel included in the display module 200 includes the electrode used to drive the display panel. Here, the electrode used to drive the display panel may vary according to the kind of the display panel. For example, when the display panel is the LCD panel 200A shown in FIG. 2a, the electrode used to drive the display panel may include at least one of a data line, a gate line, a TFT, a common electrode (Vcom), and a pixel electrode, and when the when the display panel is the OLED panel 200A shown in FIG. 2b, the electrode used to drive the display panel may include at least one of a data line, a gate line, a first power line (ELVDD), a second power line (ELVSS).

The display module 200 may include the touch sensor 10 shown in FIG. 1a or 1b.

The pressure electrodes 450 and 460 are disposed between the display module 200 and the substrate 300. In the embodiment shown in FIG. 3b, the pressure electrodes 450 and 460 are formed on the display panel of the display module 200. Here, the pressure electrodes 450 and 460 may be formed directly on the display panel of the display module 200. Here, the meaning of what the pressure electrodes 450 and 460 are formed directly is that the pressure electrodes 450 and 460 are patterned on the bottom surface of the display module 200.

The pressure electrodes 450 and 460 are provided in plural numbers. A portion of the plurality of pressure electrodes 450 and 460 may be drive electrodes to which the drive signal Tx is applied, the remaining pressure electrodes may be sensing electrodes from which the sensing signal Rx is output. Further, each of the plurality of pressure electrodes 450 and 460 may receive the drive signal Tx and output the sensing signal Rx.

The substrate 300 is disposed below the display module 200. The substrate 300 is made of a conductive material and may be the reference potential layer of the pressure electrodes 450 and 460.

When the display module 200 is bent by the pressure applied to the surface of the touch input device, the distance between the pressure electrodes 450 and 460 and the substrate 300 that is the reference potential layer changes. Then, the capacitance between he pressure electrodes 450 and 460 and the substrate 300 changes by the changed distance, and then the change of the capacitance can be sensed from the pressure electrodes 450 and 460. Here, the change amount of the capacitance detected from the pressure electrodes 450 and 460 may include the parasitic capacitance between the pressure electrodes 450 and 460 and the electrode used to drive the display panel included in the display module 200. The parasitic capacitance is formed when one or more of various electrodes used to drive the display panel 200 serve as the reference potential layer. The parasitic capacitance is increased when the distance between the pressure electrodes 450 and 460 and one or more of various electrodes used to drive the display panel 200 becomes smaller.

In order to significantly reduce or remove such a parasitic capacitance, when the drive signal Tx is applied to the pressure electrodes 450 and 460, the drive signal Tx which is applied to the pressure electrodes 450 and 460 is also applied simultaneously to one or more electrodes used to drive the display panel 200. Here, the one or more electrodes may be located closest to the pressure electrodes 450 and 460 of the electrodes used to drive the display panel 200.

When the same drive signal Tx is simultaneously applied to the pressure electrodes 450 and 460 and any one of the electrodes used to drive the display panel 200, the pressure electrodes 450 and 460 and any one of the electrodes used to drive the display panel 200 have the same electric potential, so that the parasitic capacitance cannot be formed at all or can be significantly reduced. Also, the substrate 300 that is the reference potential layer has an advantage that a signal-to-noise ratio (SNR) is improved because the drive signal Tx comes from the pressure electrodes 450 and 460 and any one of the electrodes used to drive the display panel 200.

FIG. 3c is a cross sectional view of the touch input device according to the second example, which is for describing the method for significantly reducing or removing the parasitic capacitance formed between the display module 200 and the pressure electrodes 450 and 460 in the change amount of the capacitance detected from the pressure electrodes 450 and 460.

The touch input device shown in FIG. 3c compared to the touch input device shown in FIG. 3b has the pressure sensor 440 including the pressure electrodes 450 and 460.

The pressure electrodes 450 and 460 are disposed within the pressure sensor 440. To this end, the pressure sensor 440 may include an insulation layer surrounding the pressure electrodes 450 and 460. Here, the insulation layer may include the first insulation layer and the second insulation layer. One side of the pressure sensor 440, that is, one of the first insulation layer and the second insulation layer is formed on the display module 200.

The distance between the pressure electrodes 450 and 460 and one of the electrodes used to drive the display panel 200 in the touch input device shown in FIG. 3c is greater than the distance between the pressure electrodes 450 and 460 and one of the electrodes used to drive the display panel 200 in the touch input device shown in FIG. 3b. However, in also the touch input device shown in FIG. 3c, the parasitic capacitance between the pressure electrodes 450 and 460 and one of the electrodes used to drive the display panel 200 may be included in the change amount of the capacitance detected from the pressure electrodes 450 and 460. Therefore, in also the touch input device shown in FIG. 3c, it is possible to significantly reduce the parasitic capacitance by using the method in the touch input device shown in FIG. 3b, that is to say, the method of simultaneously applying the drive signal Tx which is applied to the pressure electrodes 450 and 460 to one of the electrodes used to drive the display panel 200.

FIG. 3d is a cross sectional view of the touch input device according to the third example, which is for describing the method for significantly reducing or removing the parasitic capacitance formed between the substrate 300 and the pressure electrodes 450 and 460 in the change amount of the capacitance detected from the pressure electrodes 450 and 460.

The touch input device shown in FIG. 3d is different from the touch input device shown in FIG. 3b in that the pressure electrodes 450 and 460 are formed on the substrate 300 not on the display module 200. The reference potential layer (not shown) of the pressure electrodes 450 and 460 is formed inside or outside the display module 200.

In the touch input device shown in FIG. 3d, the parasitic capacitance between the pressure electrodes 450 and 460 and the substrate 300 may be included in the change amount of the capacitance detected from the pressure electrodes 450 and 460. The parasitic capacitance can be formed because the substrate 300 has the same electric potential as the reference potential layer of the display module 200.

In order to significantly reduce or remove such a parasitic capacitance, when the drive signal Tx is applied to the pressure electrodes 450 and 460, the drive signal Tx which is applied to the pressure electrodes 450 and 460 is also applied simultaneously to the substrate 300. When the same drive signal Tx is simultaneously applied to the pressure electrodes 450 and 460 and the substrate 300, the pressure electrodes 450 and 460 and the substrate 300 have the same electric potential, so that the parasitic capacitance cannot be formed at all or can be significantly reduced. Also, the substrate 300 that is the reference potential layer has an advantage that a signal-to-noise ratio (SNR) is improved because the drive signal Tx comes from the pressure electrodes 450 and 460 and the substrate 300.

FIG. 3e is a cross sectional view of the touch input device according to the fourth example, which is for describing the method for significantly reducing or removing the parasitic capacitance formed between the substrate 300 and the pressure electrodes 450 and 460 in the change amount of the capacitance detected from the pressure electrodes 450 and 460.

The touch input device shown in FIG. 3e is different from the touch input device shown in FIG. 3c in that the pressure sensor 440 including the pressure electrodes 450 and 460 is formed on the substrate 300. The reference potential layer (not shown) of the pressure electrodes 450 and 460 is formed inside or outside the display module 200.

In the touch input device shown in FIG. 3e, the parasitic capacitance can be significantly reduced by using the method in the touch input device shown in FIG. 3d, that is to say, by using the method of simultaneously applying the drive signal Tx which is applied to the pressure electrodes 450 and 460 to the substrate 300.

FIG. 3f is a cross sectional view of the touch input device according to a fifth example, which is for describing the method for significantly reducing or removing the parasitic capacitance formed between the display module 200 and the pressure electrodes 450 and 460 in the change amount of the capacitance detected from the pressure electrodes 450 and 460.

The touch input device shown in FIG. 3f is different from the touch input device shown in FIG. 3b in that at least one pressure electrode 450 is formed on the display panel 200 and at least one pressure electrode 460 is formed on the substrate 300. For convenience of description, the pressure electrode 450 formed on the display panel 200 is referred to as a first pressure electrode and the pressure electrode 460 formed on the substrate 300 is referred to as a second pressure electrode. Here, the first pressure electrode 450 may be formed directly on the display panel 200 and the second pressure electrode 460 may be formed directly on the substrate 300.

In the touch input device shown in FIG. 3f, the first pressure electrode 450 may be a drive electrode to which a drive signal is applied, and the second pressure electrode 460 may be a sensing electrode which outputs a sensing signal, and vice versa. Therefore, the drive signal may be applied to one of the first pressure electrode 450 and the second pressure electrode 460, and a sensing signal may be output to the other electrode.

When the drive signal is applied to one of the first pressure electrode 450 and the second pressure electrode 460, the capacitance detected at the other electrode to which no drive signal is applied among the first pressure electrode 450 and the second pressure electrode 460 is changed by the distance change between the first pressure electrode 450 and the second pressure electrode 460 due to the pressure applied to the touch surface of the touch input device shown in FIG. 3f. Here, the magnitude of the pressure applied to the touch surface can be calculated based on the detected capacitance calculated from the mutual capacitance which is detected at the other electrode.

The display panel 200 includes, as described with reference to FIG. 3b, the electrodes used to drive the display panel.

The drive signal Tx which is applied to one of the first pressure electrode 450 and the second pressure electrode 460 is simultaneously applied to at least one of the substrate 300 and at least one of the electrodes used to drive the display panel 200. For example, as shown in FIG. 3f, when the drive signal Tx is applied to the first pressure electrode 450, the drive signal Tx may be simultaneously applied to at least one of the electrodes used to drive the display panel 200. Furthermore, though not shown in FIG. 3f, the drive signal Tx may be simultaneously applied to the substrate 300 or may be simultaneously applied to both the substrate 300 and at least one of the electrodes used to drive the display panel 200.

As such, when the drive signal Tx which is applied to one of the first pressure electrode 450 and the second pressure electrode 460 is simultaneously applied to at least one of the substrate 300 and at least one of the electrodes used to drive the display panel 200, the pressure electrode to which the drive signal Tx is applied and at least one electrode of the electrodes used to drive the display panel 200, the substrate 300 and the pressure electrode to which the drive signal Tx is applied, or the pressure electrode to which the drive signal Tx is applied, one electrode of the display panel 200, and the substrate 300 have the same electric potential, so that the parasitic capacitance cannot be formed at all or can be significantly reduced. The other electrode which outputs the sensing signal has an advantage that a signal-to-noise ratio (SNR) is improved because the drive signal Tx becomes stronger.

Meanwhile, in the touch input device shown in FIG. 3f, the reference potential layer (not shown) may not be formed anywhere on the display panel 200 and the substrate 300. Otherwise, the reference potential layer (not shown) may be formed on either the display panel 200 or the substrate 300.

In the meantime, though not shown in a separate figure, the touch input device shown in FIG. 3b may further include the pressure sensor 440 including the pressure electrodes 450 and 460 of the touch input device shown in FIG. 3e. Specifically, the pressure sensor 440 shown in FIG. 3e may be disposed on the substrate 300 shown in FIG. 3b.

In the touch input device according to this embodiment, for convenience of description, the pressure electrodes 450 and 460 formed on the display panel 200 are referred to as the first pressure electrode, and the pressure electrodes 450 and 460 of the pressure sensor 440, which are formed on the substrate 300, are referred to as the second pressure electrode. The drive signal Tx may be applied to the first pressure electrode, and the sensing signal Rx may be output to the second pressure electrode. The magnitude of the pressure applied to the touch surface of the touch input device can be calculated on the basis of the capacitance change amount according to the distance change between the first pressure electrode and the second pressure electrode, which is included in the output sensing signal Rx.

The second pressure electrode may be included in the pressure sensor 440 shown in FIG. 3e. This pressure sensor 440 may include the first insulation layer and the second insulation layer which are disposed on and under the second pressure electrode respectively. One of the first insulation layer and the second insulation layer may be formed on the substrate 300.

The pressure sensor 400 including the second pressure electrode, the first insulation layer, and the second insulation layer may have a sheet shape. The sheet-shaped pressure sensor 400 may be attached to the substrate 300.

Also in the touch input device, by using the same method as that of the touch input device shown in FIG. 3b, that is to say, by using the method of simultaneously applying the drive signal Tx which is applied to the pressure electrodes 450 and 460 to at least one of the electrodes used to drive the display panel 200, the parasitic capacitance can be significantly reduced.

Though not shown in a separate figure, the pressure electrodes 450 and 460 shown in FIG. 3d may be formed directly on the substrate 300 of the touch input device shown in FIG. 3b. The pressure electrodes 450 and 460 shown in FIG. 3d may be formed directly on the substrate 300 of the touch input device shown in FIG. 3c, or the pressure sensor 440 shown in FIG. 3e may be formed on the substrate 300 of the touch input device shown in FIG. 3c.

In order to detect the pressure through the touch input device 1000 to which the pressure sensor is applied according to the embodiment of the present invention, it is necessary to sense the capacitance change occurring in the pressure electrodes 450 and 460. Therefore, it is necessary for the drive signal to be applied to the drive electrode out of the first and second electrodes 450 and 460, and it is required to detect the touch pressure by the capacitance change amount by obtaining the sensing signal from the receiving electrode. According to the embodiment, it is possible to additionally include a pressure detection device in the form of a pressure sensing IC for the operation of the pressure detection. The pressure detection module 400 according to the embodiment of the present invention may include not only the pressure sensor for pressure detection but also the pressure detection device.

In this case, the touch input device repeatedly has a configuration similar to the configuration of FIG. 1 including the drive unit 12, sensing unit 11, and controller 13, so that the area and volume of the touch input device 1000 increase.

According to the embodiment, the touch detection device 1000 may apply the drive signal for pressure detection to the pressure sensor by using the touch detection device for the operation of the touch sensor panel 100, and may detect the touch pressure by receiving the sensing signal from the pressure sensor. Hereinafter, the following description will be provided by assuming that the first electrode 450 is the drive electrode and the second electrode 460 is the receiving electrode.

For this, in the touch input device 1000 to which the pressure sensor is applied according to the embodiment of the present invention, the drive signal may be applied to the first electrode 450 from the drive unit 12, and the second electrode 460 may transmit the sensing signal to the sensing unit 11. The controller 13 may perform the scanning of the touch sensor 10, and simultaneously perform the scanning of the touch pressure detection, or the controller 13 performs the time-sharing, and then may generate a control signal such that the scanning of the touch sensor 10 is performed in a first time interval and the scanning of the pressure detection is performed in a second time interval different from the first time interval.

Therefore, in the embodiment of the present invention, the first electrode 450 and the second electrode 460 should be electrically connected to the drive unit 12 and/or the sensing unit 11. Here, it is common that the touch detection device for the touch sensor 10 corresponds to a touch sensing IC 150 and is formed on one end of the touch sensor 10 or on the same plane with the touch sensor 10. The pressure electrode 450 and 460 included in the pressure sensor may be electrically connected to the touch detection device of the touch sensor 10 by any method.

FIGS. 11a to 11b show that pressure sensor in the form of the pressure sensor 440 including the pressure electrodes 450 and 460 is attached to the bottom surface of the display module 200. FIGS. 11a and 11b show the second PCB 210 on which a circuit for the operation of the display panel has been mounted is disposed on a portion of the bottom surface of the display module 200.

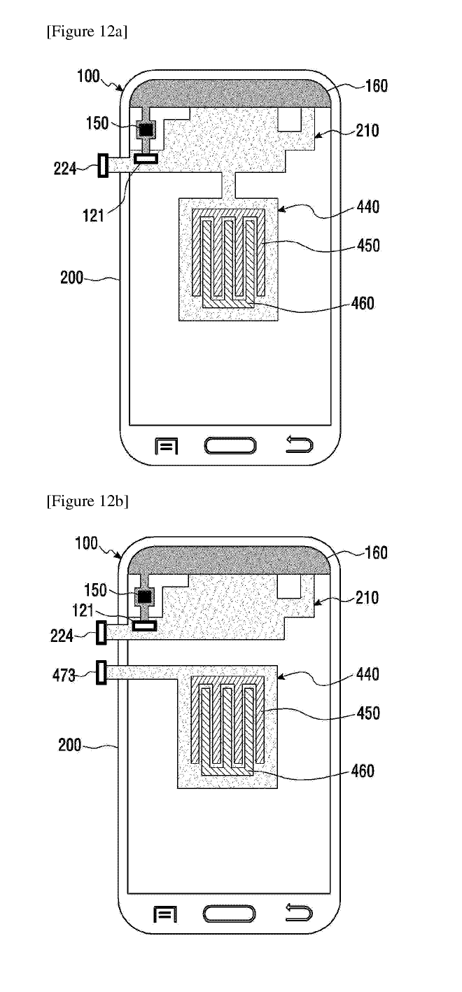

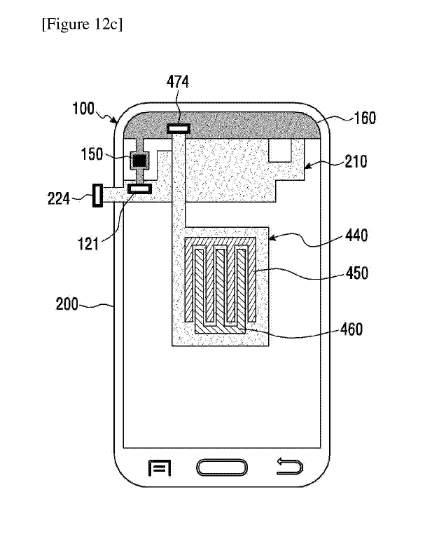

FIG. 11a shows that the pressure sensor 440 is attached to the bottom surface of the display module 200 such that the first electrode 450 and the second electrode 460 are connected to one end of the second PCB 210 of the display module 200. Here, the first electrode 450 and the second electrode 460 may be connected to the one end of the second PCB 210 by using a double conductive tape. Specifically, since the thickness of the pressure sensor 440 and an interval between the substrate 300 and the display module 200 where the pressure sensor 440 is disposed are very small, the thickness can be effectively reduced by connecting both the first electrode 450 and the second electrode 460 to the one end of the second PCB 210 by using the double conductive tape rather than by using a separate connector. A conductive pattern may be printed on the second PCB 210 in such a manner as to electrically connect the pressure electrodes 450 and 460 to a necessary component like the touch sensing IC 150, etc. The detailed description of this will be provided with reference to FIGS. 12a to 12c. An attachment method of the pressure sensor 440 including the pressure electrodes 450 and 460 shown in FIG. 11a can be applied in the same manner to the substrate 300.

FIG. 11b shows that the pressure electrodes 450 and 460 are not manufactured of a separate electrode sheet but are integrally formed on the second PCB 210 of the display module 200. For example, when the second PCB 210 of the display module 200 is manufactured, a certain area is separated from the second PCB, and then not only the circuit for the operation of the display panel but also the pattern corresponding to the first electrode 450 and the second electrode 460 can be printed on the area. A conductive pattern may be printed on the second PCB 210 in such a manner as to electrically connect the first electrode 450 and the second electrode 460 to a necessary component like the touch sensing IC 150, etc.

FIGS. 12a to 12c show a method for connecting the pressure electrodes 450 and 460 or the pressure sensor 440 to the touch sensing IC 150. In FIGS. 12a to 12c, the touch sensor panel 100 is included outside the display module 200. FIGS. 12a to 12c show that the touch detection device of the touch sensor panel 100 is integrated in the touch sensing IC 150 mounted on the first PCB 160 for the touch sensor panel 100.

FIG. 12a shows that the pressure electrodes 450 and 460 attached to the display module 200 are connected to the touch sensing IC 150 through a first connector 121. As shown in FIG. 12a, in a mobile communication device such as a smart phone, the touch sensing IC 150 is connected to the second PCB 210 for the display module 200 through the first connector 121. The second PCB 210 may be electrically connected to the main board through a second connector 224. Therefore, through the first connector 121 and the second connector 224, the touch sensing IC 150 may transmit and receive a signal to and from the CPU or AP for the operation of the touch input device 1000.

Here, while FIG. 12a shows that the pressure sensor 440 is attached to the display module 200 by the method shown in FIG. 11b, the first electrode 450 can be attached to the display module 200 by the method shown in FIG. 1a. A conductive pattern may be printed on the second PCB 210 in such a manner as to electrically connect the first electrode 450 and the second electrode 460 to the touch sensing IC 150 through the first connector 121.

FIG. 12b shows that the pressure electrodes 450 and 460 attached to the display module 200 are connected to the touch sensing IC 150 through a third connector 473. In FIG. 12b, the pressure electrodes 450 and 460 may be connected to the main board for the operation of the touch input device 1000 through the third connector 473, and in the future, may be connected to the touch sensing IC 150 through the second connector 224 and the first connector 121. Here, the pressure electrodes 450 and 460 may be printed on the additional PCB separated from the second PCB 210. Otherwise, according to the embodiment, the pressure electrodes 450 and 460 may be attached to the touch input device 1000 in the form of the pressure sensor 440 shown in FIGS. 3b to 3i and may be connected to the main board through the connector 473 by extending the conductive trace, etc., from the pressure electrodes 450 and 460.

FIG. 12c shows that the pressure electrodes 450 and 460 are directly connected to the touch sensing IC 150 through a fourth connector 474. In FIG. 12c, the pressure electrodes 450 and 460 may be connected to the first PCB 160 through the fourth connector 474. A conductive pattern may be printed on the first PCB 160 in such a manner as to electrically connect the fourth connector 474 to the touch sensing IC 150. As a result, the pressure electrodes 450 and 460 may be connected to the touch sensing IC 150 through the fourth connector 474. Here, the pressure electrodes 450 and 460 may be printed on the additional PCB separated from the second PCB 210. The second PCB 210 may be insulated from the additional PCB so as not to be short-circuited with each other. Also, according to the embodiment, the pressure electrodes 450 and 460 may be attached to the touch input device 1000 in the form of the pressure sensor 440 shown in FIGS. 3b to 3i and may be connected to the first PCB 160 through the connector 474 by extending the conductive trace, etc., from the pressure electrodes 450 and 460.

The connection method of FIGS. 12b and 12c can be applied to the case where the pressure electrode 450 and 460 are formed on the substrate 300 as well as on the bottom surface of the display module 200.

FIGS. 12a to 12c have been described by assuming that a chip on board (COB) structure in which the touch sensing IC 150 is formed on the first PCB 160. However, this is just an example. The present invention can be applied to the chip on board (COB) structure in which the touch sensing IC 150 is mounted on the main board within the mounting space 310 of the touch input device 1000. It will be apparent to those skilled in the art from the descriptions of FIGS. 12a to 12c that the connection of the pressure electrodes 450 and 460 through the connector can be also applied to another embodiment.

The foregoing has described the pressure electrodes 450 and 460, that is to say, has described that the first electrode 450 constitutes one channel as the drive electrode and the second electrode 460 constitutes one channel as the receiving electrode. However, this is just an example. According to the embodiment, the drive electrode and the receiving electrode constitute a plurality of channels respectively, so that it is possible to detect multi pressure according to multi touch.

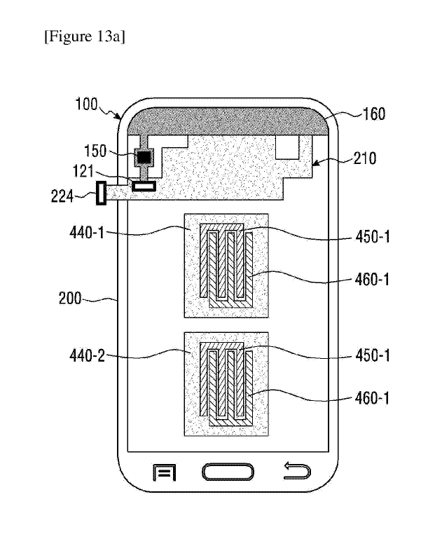

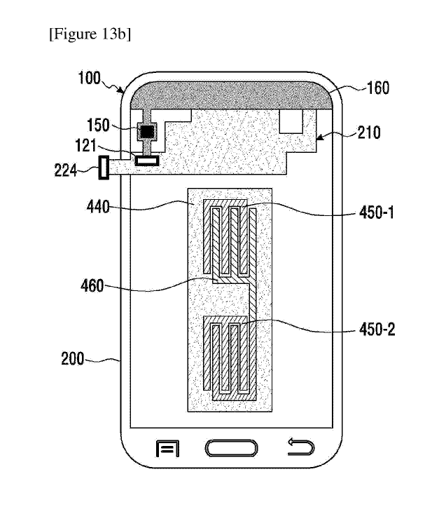

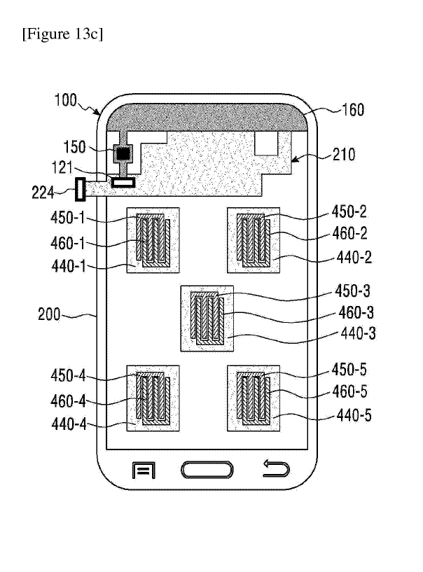

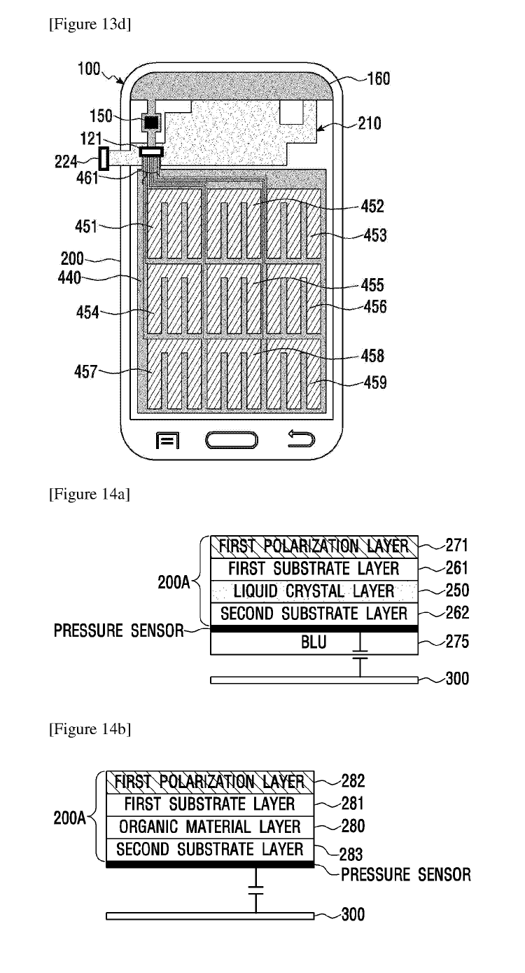

FIGS. 13a to 13d show that the pressure electrode of the present invention constitutes the plurality of channels. FIG. 13a shows first electrodes 450-1 and 450-2 and second electrodes 460-1 and 460-2 constitute two channels respectively. Though FIG. 13a shows that the first electrode 450-1 and the second electrode 460-1 which constitute a first channel are included in the first pressure sensor 440-1 and the first electrode 450-2 and the second electrode 460-2 which constitute a second channel are included in the second pressure sensor 440-2, all of the first electrodes 450-1 and 450-2 and the second electrodes 460-1 and 460-2 which constitute the two channels may be included in one pressure sensor 440. FIG. 13b shows that the first electrodes 450-1 and 450-2 constitute two channels and the second electrode 460 constitutes one channel. FIG. 13c shows the first electrode 450-1 to 450-5 constitute five channels and the second electrode 460-1 to 460-5 constitute five channels. Even in this case, all of the electrodes constituting the five channels may be also included in one pressure sensor 440. FIG. 13d shows that first electrodes 451 to 459 constitute nine channels and all of the first electrodes 451 to 459 are included in one pressure sensor 440.

As shown in FIGS. 13a to 13d and 15a to 15c, when the plurality of channels are formed, a conductive pattern which is electrically connected to the touch sensing IC 150 from each of the first electrode 450 and/or the second electrode 460 may be formed.

Here, described is a case in which the plurality of channels shown in FIG. 13d are constituted. In this case, since a plurality of conductive patterns 461 should be connected to the first connector 121 with a limited width, a width of the conductive pattern 461 and an interval between the adjacent conductive patterns 461 should be small. Polyimide is more suitable for a fine process of forming the conductive pattern 461 with such a small width and interval than polyethylene terephthalate. Specifically, the first insulation layer 470 or the second insulation layer 471 of the pressure sensor 440, in which the conductive pattern 461 is formed, may be made of polyimide. Also, a soldering process may be required to connect the conductive pattern 461 to the first connector 121. For a soldering process which is performed at a temperature higher than 300° C. polyimide resistant to heat is more suitable than polyethylene terephthalate relatively vulnerable to heat. Here, for the purpose of reducing production costs, a portion of the first insulation layer 470 or the second insulation layer 471, in which the conductive pattern 461 is not formed, may be made of polyethylene terephthalate, and a portion of the first insulation layer 470 or the second insulation layer 471, in which the conductive pattern 461 is formed, may be made of polyimide.

FIGS. 13a to 13d and 15a to 15c show that the pressure electrode constitutes a single or a plurality of channels. The pressure electrode may be comprised of a single or a plurality of channels by a variety of methods. While FIGS. 13a to 13c and 15a to 15c do not show that the pressure electrodes 450 and 460 are electrically connected to the touch sensing IC 150, the pressure electrodes 450 and 460 can be connected to the touch sensing IC 150 by the method shown in FIGS. 12a to 12c and other methods.

In the foregoing description, the first connector 121 or the fourth connector 474 may be a double conductive tape. Specifically, since the first connector 121 or the fourth connector 474 may be disposed at a very small interval, the thickness can be effectively reduced by using the double conductive tape rather than a separate connector.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

### REFERENCE NUMERALS

```
1000: touch input device
  10: touch sensor
  12: drive unit
  11: sensing unit
  13: control unit
  200: display module
  300: substrate
  400: pressure detection module
  420; spacer layer
  430: frame
  440: pressure sensor
  450, 460: pressure electrode
  470: first insulation layer
  471: second insulation layer
  480: reference pressure electrode
```

1. A touch input device capable of detecting pressure of a touch on a touch surface, the touch input device comprising:
a display module comprising a display panel;
a substrate which is disposed below the display module and is a reference potential layer; and
one or more pressure electrodes which are formed on the display panel,
the display panel comprises electrodes used to drive the display panel,
wherein a drive signal Tx which is applied to the pressure electrode is simultaneously applied to one or more of the electrodes used to drive the display panel,
wherein a capacitance which is detected at the pressure electrode is changed by a distance change between the pressure electrode and the substrate due to the pressure applied to the touch surface,
and wherein a magnitude of the pressure applied to the touch surface is calculated based on the detected capacitance calculated from the capacitance which is detected at the pressure electrode.

2. The touch input device of claim 1, wherein the pressure electrode is formed directly on the display panel.

3. The touch input device of claim 2,
wherein the display panel comprises a first substrate layer and a second substrate layer which is disposed under the first substrate layer,
and wherein the pressure electrode is formed directly on a bottom surface of the second substrate layer.

4. The touch input device of claim 1, further comprising a pressure sensor comprising the pressure electrode,
wherein the pressure sensor further comprises a first insulation layer and a second insulation layer,
wherein the pressure electrode is disposed between the first insulation layer and the second insulation layer,
and wherein one of the first insulation layer and the second insulation layer is attached to the display panel.

5. A touch input device capable of detecting pressure of a touch on a touch surface, the touch input device comprising:
a display module which comprises a display panel and has a reference potential layer;
a substrate which is disposed below the display module; and
one or more pressure electrodes which are formed on the substrate,
wherein a drive signal Tx which is applied to the pressure electrode is simultaneously applied to the substrate,
wherein a capacitance which is detected at the pressure electrode is changed by a distance change between the pressure electrode and the reference potential layer due to the pressure applied to the touch surface,
and wherein a magnitude of the pressure applied to the touch surface is calculated based on the detected capacitance calculated from the capacitance which is detected at the pressure electrode.

6. The touch input device of claim 5, wherein the pressure electrode is formed directly on the substrate.

7. The touch input device of claim 5, further comprising a pressure sensor comprising the pressure electrode,
wherein the pressure sensor further comprises a first insulation layer and a second insulation layer,
wherein the pressure electrode is disposed between the first insulation layer and the second insulation layer,
and wherein one of the first insulation layer and the second insulation layer is attached to the substrate.

8. A touch input device capable of detecting pressure of a touch on a touch surface, the touch input device comprising:
a display module which comprises a display panel;
a substrate disposed below the display module;
a first pressure electrode formed on the display panel; and
a second pressure electrode formed on the substrate,
wherein the display panel comprises electrodes used to drive the display panel,
wherein a drive signal Tx which is applied to one of the first pressure electrode and the second pressure electrode is simultaneously applied to at least one of the substrate and at least one of the electrodes used to drive the display panel,
wherein a capacitance detected at the other electrode to which no drive signal is applied among the first pressure electrode and the second pressure electrode is changed by a distance change between the first pressure electrode and the second pressure electrode due to the pressure applied to the touch surface,
and wherein a magnitude of the pressure applied to the touch surface is calculated based on the detected capacitance calculated from the capacitance which is detected at the other pressure electrode.

9. The touch input device of claim 8, wherein the one of the first pressure electrode and the second pressure electrode is the first pressure electrode, and the other electrode is the second pressure electrode.

10. The touch input device of claim 8, wherein the first pressure electrode is formed directly on the display panel.

11. The touch input device of claim 8, comprising a pressure sensor comprising the second pressure electrode, wherein the pressure sensor further comprises a first insulation layer and a second insulation layer, wherein the second pressure electrode is disposed between the first insulation layer and the second insulation layer, and wherein one of the first insulation layer and the second insulation layer is attached to the substrate.

12. The touch input device of claim 1, wherein the display panel is bent by the pressure applied to the touch surface.

13. The touch input device of claim 5, wherein the display panel is bent by the pressure applied to the touch surface.

14. The touch input device of claim 8, wherein the display panel is bent by the pressure applied to the touch surface.
